(19) United States
(12) Patent Application Publication
(10) Pub. No.: US 2026/0112515 A1
(43) Pub. Date: Apr. 23, 2026

(54) PRODUCTION AND STORAGE OF METAL OXIDE OBJECTS HAVING A METALLIC COATING

(71) Applicant: Battelle Memorial Institute, Richland, WA (US)

(72) Inventors: Jeffrey A. Katalenich, West Richland, WA (US); Brittany N. Robertson, Richland, WA (US); Cristina Padilla Cintron, Indian Land, SC (US); Kellen Traxel, Richland, WA (US); David A. Koch, Richland, WA (US); Lance R. Hubbard, Richland, WA (US); Christina L. Arendt, Santa Fe, NM (US)

(21) Appl. No.: 19/365,057

(22) Filed: Oct. 21, 2025

Related U.S. Application Data
(60) Provisional application No. 63/709,930, filed on Oct. 21, 2024.

(51) Int. Cl. G21G 4/06; C23C 18/14

(52) U.S. Cl. CPC G21G 4/06; C23C 18/14

(57) ABSTRACT

One or more implementations relate to performing processes to form metallic coatings on metal oxide-containing objects. In one or more additional implementations, structures are formed to store the coated metal-oxide containing objects. In various implementations, the metal-oxide containing objects can be produced by sol-gel processes.

### PRIORITY CLAIM

This application claims the benefit of priority to U.S. Provisional Application No. 63/709,930, filed on Oct. 21, 2024, and entitled “Infusion and/or coating of inert sol-gel microspheres,” the contents of which are incorporated by reference herein in their entirety.

### STATEMENT AS TO RIGHTS TO DISCLOSURES MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### FIELD OF THE INVENTION

One or more implementations relate to performing processes to form metallic coatings on metal oxide-containing objects. In one or more additional implementations, structures are formed to store the coated metal-oxide containing objects. In various implementations, the metal-oxide objects can be produced by sol-gel processes.

### BACKGROUND

Metal oxides can be formed when metals react with oxygen. Metal oxides can be used in industries ranging from the semiconductor industry to the food science industry to medical applications. In some instances, metal oxides can be formed into micron-sized objects or nanometer-sized objects for use in a given setting. Various metal oxides can be used as catalysts to increase the rate of chemical reactions. Other metal oxides can be used in the alternative energy industry as radioisotope heat and power sources.

### BRIEF DESCRIPTION OF THE DRAWINGS

FIG. 1 illustrates a process to produce coated metal oxide-containing objects, in accordance with one or more example implementations.

FIG. 2 illustrates a process to produce amine functionalized metal oxide-containing objects and to form a metal coated metal-oxide containing objects, in accordance with one or more example implementations.

FIG. 3 illustrates a process to produce first examples of a storage container for coated metal oxide-containing objects, in accordance with one or more example implementations.

FIG. 4 illustrates a process to produce second examples of a storage container for coated metal oxide-containing objects, in accordance with one or more example implementations.

FIG. 5A illustrates a third example of a storage container for coated metal oxide-containing objects, in accordance with one or more example implementations.

FIG. 5B a cross-sectional view of the third example of a storage container for coated metal oxide-containing objects, in accordance with one or more example implementations.

FIG. 6 is a graphical representation of thermal conductivities as functions of temperature for transition metals in period 4, groups 3-10: Sc, Ti, V, Cr, Mn, Fe, Co, Ni.

FIG. 7 is a graphical representation of thermal conductivities as functions of temperature for transition metals in period 5, groups 3-10: Y, Zr, Nb, Mo, Tc, Ru, Rh, Pd.

FIG. 8 is a graphical representation of thermal conductivities as functions of temperature for transition metals in period 6, groups 3-10: La, Hf, Ta, W, Re, Os, Ir, Pt.

FIG. 9 is a graphical representation of room temperature elastic (Young's) moduli of period 5 and period 6 transition metals.

FIG. 10 is a graphical representation of elastic (Young's) moduli of period 5 and period 6 transition metals as functions of temperature from 0° C. to 1,000° C.

FIG. 11 is an XPS spectrum showing the atomic constituents of the surface of the cerium microspheres fired to 1,600° C. with an inlay micrograph of the spheres.

FIG. 12 is an XPS spectrum showing the atomic constituents of the surface of the cerium microspheres fired to 650° C. with an inlay micrograph of the spheres.

FIG. 13 is an XPS spectrum showing the atomic constituents of the control background adherent.

FIG. 14 is an XPS spectrum showing the atomic constituents of the surface of the cerium microspheres fired to 650° C.

FIG. 15 is an XPS spectrum showing the atomic constituents of the surface of the amine-terminated cerium microspheres in showing the addition of nitrogen responses.

FIG. 16 is an XPS spectrum showing the atomic constituents of the surface of iridium-coated cerium microspheres with responses from iridium present.

FIG. 17 shows at item A, an SEM micrograph of an uncoated cerium oxide microsphere, with a demarcation of the pores; at Item B, an SEM micrograph of an iridium-coated microsphere; at Item C, an EDS map of the cerium response from an iridium-coated microsphere, and; at Item D, an EDS map of the iridium response of an iridium-coated microsphere.

FIG. 18 shows at Item A, a Brightfield Micrograph of a mixture of Ti plated onto CeO₂ (dark spheres) and uncoated CeO₂ (yellow smaller spheres) for a direct in-image size comparison; at Item B, ambient light of a collection of iridium-coated cerium spheres after heating at 250° C. in a vacuum for 72 hours; at Item C, a Brightfield Image of the spheres from Item B showing the reflective aspect of the coating; at Item D, a Dark Field image of the spheres showing that the transmission of the ceria cores is completely occluded by the coating; at Item E, a UV Micrograph of the spheres showing no salts present on the surface of the coating; and at Item F, a 600-980 nm reflectance micrograph showing no oxide signal from the coated spheres.

FIG. 19 includes graphical representations at Item A of the thickness of each metallic shell color-coded to the end chemical state of the coating; at Item B the coating's reduction potential plotted vs. the electronegativity of the constituent atom; at Item C, the shell thickness of attempted alloy coatings with the end state of the shell; and at Item D, the results of the leaching of cerium from spheres by way of 72 hr. ambient methanol addition.

### DETAILED DESCRIPTION

The following description includes a preferred best mode of implementations of the present disclosure. It will be clear from this description of the disclosure that the disclosure is not limited to these illustrated implementations but that the disclosure also includes a variety of modifications and embodiments thereto. Therefore, the present description should be seen as illustrative and not limiting. While the disclosure is susceptible of various modifications and alternative constructions, it should be understood, that there is no intention to limit the disclosure to the specific form disclosed, but, on the contrary, the disclosure is to cover all modifications, alternative constructions, and equivalents falling within the spirit and scope of the disclosure.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, “about” or “approximately” as applied to one or more values or elements of interest, refers to a value or element that is similar to a stated reference value or element. In certain implementations, the term “about” or “approximately” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

As the demand for alternative power sources increase, interest has increased in reducing the cost and increasing the manufacturability of radioisotope heat and power sources. Additionally, interest has also increased for identifying techniques for improving the safety of radioisotope heat and power sources. Metal oxide objects, such as spheres or powders, can be formed from sol-gel processes. In one or more examples, sol-gel processes can be used to produce micron-sized objects that act as radioisotope heat sources.

Described herein are methods for microsphere infusion and microsphere coating as two augmentations of existing sol-gel microsphere processing as a way to reduce the radiation hazards. In one or more examples, methods are described to infuse inert metal oxide microspheres (such as alumina) with either target materials (for subsequent irradiation and transmutation of the loaded species) or desired radioactive species. This approach can be desirable because it allows for sol-gel production equipment and processing steps to take place in a non-radiological environment (as opposed to performing sol-gel using a feed solution that contains the radioactive species and requires radiological operations). Additionally, this approach can decrease the releasability of the radioactive species from the matrix material in the event of exposure to the environment. Further, these techniques can provide a low-z matrix for beta radiation emission absorption, decreasing bremsstrahlung production. In still other examples, these implementations can enable the incorporation of heat-producing species into a more thermally conductive, yet refractory, matrix material than a pure metal oxide of that heat-producing isotope.

In additional examples, methods are described to use a coating technology, such as electroless autocatalytic deposition of metals, to apply a coating around the outside layer of microspheres. This approach can be desirable because it can result in increasing the thermal conductivity of a packed assembly of heat-producing microspheres, lowering the thermal gradient, improving the retention of the metal oxide microsphere material and any sorbed species, decreasing the releasability in the event of exposure to the environment, and reducing the generation of dust from microspheres subjected to vibrations or impact that would otherwise cause the generation of small metal oxide fines.

In one or more implementations, the methods described herein can be directed to the use of an inert matrix material doped with a target species. For the case of a radiological dopant, the infusion pathway allows for sol-gel metal oxide microspheres to be produced in a non-radiological environment, decreasing the cost of operations and waste disposal (especially the liquid waste stream). Additionally, the non-radioactive, inert matrix spheres can be made porous and suitable for infusing a target species (by placing the metal oxide microsphere in a solution containing the target element/isotope to be infused followed by drying and heat treatments). Thus, only the sorption step needs to occur under radiological controls, significantly simplifying the overall process. In still other examples, a target element/isotope can be infused into an inert matrix prior to irradiation and transmutation to form the desired isotope(s). For fuels, it's possible to dope in species to improve thermal conductivity or burnable absorbers, etc.

With respect to radioisotope heat and power sources, a radioactive species (or target material for irradiation to produce a radioactive species) can be infused into microspheres of an inert and/or conductive material (which may also have a low neutron activation cross section). This could enable non-radioactive synthesis of the matrix and simplify the radioactive handling aspects. It could also improve the safety by reducing the potential for radioactive material release into the environment (since it is bound into a stable matrix). The safety (and/or thermal conductivity) would be further improved by the application of a metallic coating.

In further situations related to radioactive heat and power sources, a beta emitter of interest can be infused into solgel microspheres composed of a low-z matrix (such as alumina) so that there's a uniform dispersion and the beta emissions are absorbed in the low-z material. This simplifies all the powder handling/dispersibility concerns as well as pelletization. Use of an inert matrix loaded with a radioactive material can enable the use of radioactive compounds, that were previously dismissed, due to improved thermal conductivity and/or reduced releasability.

In still other examples related to radioactive heat and power sources, radioactive isotopes can be sorbed into sol-gel microspheres composed of a refractory matrix (like alumina or zirconia). This reduces its dispersibility (due to fire/loft) in an accident. This may reduce the temperature gradient in the fuel, allowing for larger fueled regions. Further, application of a metallic coating could further improve thermal conductivity and/or reduce releasability into the environment in an accident scenario. The spheres could also be larger, reducing their ability to loft and making them non-respirable.

In at least some examples, the coating processes described herein can produce coatings that completely encase metal oxide objects that are either inert or in which a radioactive isotope has been infused. These processes represent improvements over existing physical vapor deposition approaches. Additionally, the coating processes described herein represent improvements over electrodeposition techniques because of the difficulties involved in providing the electrical contacts that produce the voltages that cause deposition of a coating on the microspheres.

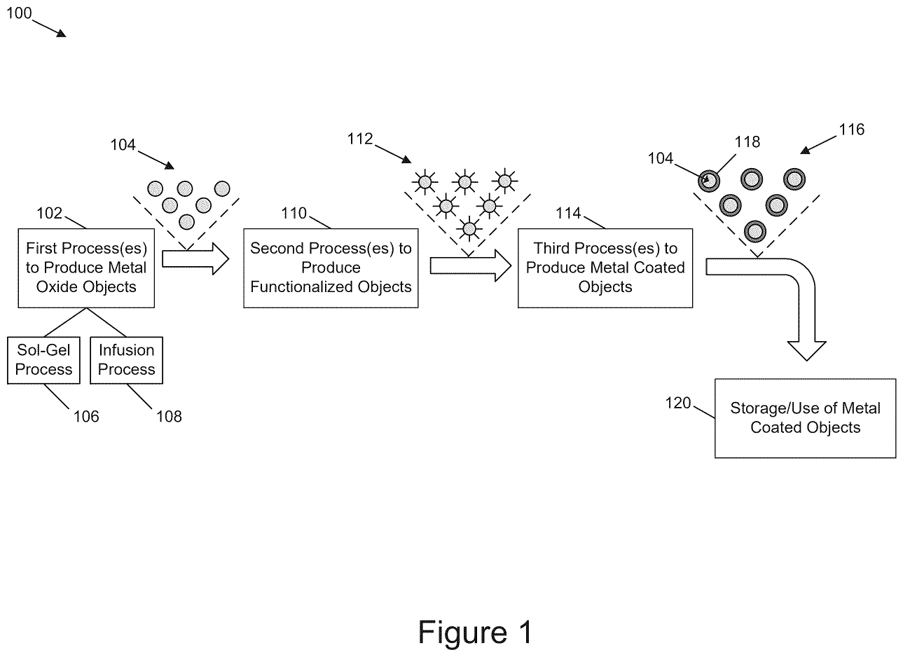

FIG. 1 illustrates a process 100 to produce coated metal oxide-containing objects, in accordance with one or more example implementations. The process 100 can include, at 102, one or more first processes to produce metal oxide objects 104. The metal oxide objects 104 can have a spherical shape. In addition, the metal oxide objects 104 can be comprised of a metal oxide material that includes at least one of a transition metal, a lanthanide, or an actinide. In one or more examples, the metal oxide objects 104 can be comprised of a plurality of metal oxides with individual metal oxides of the plurality of metal oxides being comprised of at least one of a transition metal oxide, a lanthanide oxide, or an actinide oxide. In one or more illustrative examples, the metal oxide material can include aluminum oxide.

In various examples, the metal oxide objects 104 can be comprised of a metal oxide that includes a radioactive isotope. In at least some examples, the metal oxide objects 104 can include a metal oxide material that emits alpha particles. In one or more additional examples, the metal oxide objects 104 can include a metal oxide material that emits beta particles. In still other examples, the metal oxide objects 104 can include a metal oxide material that emits gamma rays. In one or more illustrative examples, the metal oxide objects 104 can include an oxide of cerium (Ce). For example, the metal oxide objects 104 can be comprised of CeO₂. In one or more additional illustrative examples, the metal oxide objects 104 can include an oxide of plutonium (Pu). To illustrate, the metal oxide objects 104 can include PuO₂. In one or more further illustrative examples, the metal oxide objects 104 can include an oxide of uranium (U). In these scenarios, the metal oxide objects 104 can include at least one of UO₂ or U₃O₈.

The metal oxide objects 104 can also be comprised of materials that act as catalysts for one or more chemical reactions. In these instances, the metal oxide objects 104 can include an oxide of aluminum (Al). For example, the metal oxide objects 104 can be comprised of Al₂O₃. Additionally, the metal oxide objects 104 can include an oxide of yttrium (Y). To illustrate, the metal oxide objects 104 can be comprised of at least one of Y₂O₃ or YO. In still other examples, the metal oxide objects 104 can include an oxide of cerium. In these situations, the metal oxide objects 104 can be comprised of at least one of Ce₂O₃ or CeO₂. Further, the metal oxide objects 104 can include an oxide of zirconium. In these scenarios, the metal oxide objects 104 can be comprised of ZrO₂. In various examples, the metal oxide objects 104 can be comprised of oxides of other rare earth metals and/or transition metals. In one or more examples, the metal oxide objects 104 can also be comprised of one or more oxides of scandium (Sc), one or more oxides of titanium (Ti), or one or more oxides of iron (Fe).

The metal oxide objects 104 can have diameters of at least 1 micron, at least 5 microns, at least 10 microns, at least 20 microns, at least 50 microns, at least 100 microns, at least 200 microns, at least 300 microns, at least 400 microns, or at least 500 microns. Additionally, the metal oxide objects 104 can have diameters no greater than about 2000 microns, no greater than about 1800 microns, no greater than about 1500 microns, no greater than about 1200 microns, no greater than about 1000 microns, or no greater than about 800 microns. In one or more illustrative examples, the metal oxide objects 104 can have diameters from about 1 micron to about 2000 microns, from about 1 micron to about 1000 microns, from about 1 micron to about 500 microns, from about 1 micron to about 100 microns, from about 1 micron to about 20 microns, from about 20 microns to about 50 microns, from about 20 microns to about 100 microns, from about 20 microns to about 200 microns, from about 50 microns to about 100 microns, from about 50 microns to about 200 microns, from about 50 microns to about 300 microns, from about 50 microns to about 400 microns, from about 50 microns to about 500 microns, from about 100 microns to about 200 microns, from about 100 microns to about 300 microns, from about 100 microns to about 400 microns, from about 100 microns to about 500 microns, from about 100 microns to about 800 microns, from about 100 microns to about 1000 microns, from about 100 microns to about 2000 microns, from about 200 microns to about 400 microns, from about 200 microns to about 500 microns, from about 200 microns to about 800 microns, from about 200 microns to about 1000 microns, from about 200 microns to about 2000 microns, from about 400 microns to about 800 microns, from about 400 microns to about 1000 microns, from about 400 microns to about 1200 microns, from about 400 microns to about 1500 microns, from about 400 microns to about 1800 microns, from about 400 microns to about 2000 microns, from about 800 microns to about 1200 microns, from about 800 microns to about 1500 microns, from about 800 microns to about 1800 microns, from about 800 microns to about 2000 microns, from about 1200 microns to about 1500 microns, from about 1200 microns to about 1800 microns, from about 1200 microns to about 2000 microns, or from about 1500 microns to about 2000 microns.

The metal oxide objects 104 can be formed by a number of methods. In one or more examples, the metal oxide objects 104 can be formed by one or more sol-gel processes 106. The sol-gel processes 106 can include forming a colloidal solution. The colloidal solution can be prepared by combining one or more metallic precursors with one or more solvents to create an initial solution. In one or more examples, the one or more metallic precursors can be dissolved in the one or more solvents. In at least some examples, the one or more metallic precursors can include one or more metal salts or one or more alcohols. In one or more illustrative examples, the one or more solvents can include water and/or one or more acidic solutions. The colloidal solution can be formed into a gel by one or more condensation processes. The gel can comprise a network of interconnected colloidal particles. The gel can undergo an aging process, one or more drying processes, and/or one or more heat treatment processes. During the one or more aging processes, the condensation processes can proceed over a period of time. The one or more heat treatment processes can include one or more sintering processes. The metal oxide objects 104 can be recovered after the sol-gel process 106 is completed.

In one or more additional examples, the sol-gel processes 106 can include internal gelation sol-gel processes. In at least some examples, internal gelation sol-gel process can include mixing metal solutions with organic reagents. In various examples, the organic reagents can include hexamine and urea. The mixture can then be heated to induce a chemical reaction that causes hydrolysis and then gelling. The gelled spheres can be washed to remove excess reagents and byproducts and then dried to produce an oxide.

In one or more illustrative examples, the sol-gel process 106 can include at least a portion of the techniques described in Katalenich, J. A. 2017. “Production of cerium dioxide microspheres by an internal gelation sol-gel method.” Journal of Sol-Gel Science and Technology 82 (3): 654-663, which is incorporated by reference herein in its entirety. In one or more additional illustrative examples, the sol-gel process 106 can include at least a portion of the techniques described in Katalenich, J. A., B. B. Kitchen, and B. D. Pierson. 2018. “Production of monodisperse cerium oxide microspheres with diameters near 100 μm by internal-gelation sol-gel methods.” Journal of Sol-Gel Science and Technology 86 (2): 329-342, which is incorporated by reference herein in its entirety.

The metal oxide objects 104 can also be produced by one or more infusion processes 108. The one or more infusion processes 108 can include infusing inert metal oxide objects with one or more radioactive species to produce the metal oxide objects 104. In one or more examples, the inert metal oxide objects can comprise an aluminum oxide. In one or more additional examples, the inert metal oxide objects can comprise a titanium. oxide. In various examples, the one or more infusion processes 108 can include placing the inert metal oxide objects in a solution that includes the target material that is to be infused in the inert metal oxide objects. The solution can cause the inert metal oxide objects to have increased porosity that enables a target material to become infused in the pores of the inert metal oxide objects. The solution used to infuse the target material in the inert metal oxide objects can comprise an aqueous solution. Additionally, the solution used to infuse the target material in the inert metal oxide objects can comprise one or more solvents. After the inert metal oxide objects have been exposed in the solution comprising the target material for a suitable amount of time, one or more heat treatment processes can be performed to produce the metal oxide objects 104.

In one or more additional examples, the target material can include a radioactive isotope, while in other scenarios, the target material can be irradiated and undergo transmutation after being infused into the inert metal oxide objects. In scenarios where the target material includes a radioactive isotope, the target material can comprise neptunium, americium, or uranium. For example, the target material infused in the inert metal oxide objects can include neptunium-237, americium-241, or uranium-238. In one or more further examples, the inert metal oxide objects can comprise a conductive material and/or a low neutron activation material that is infused with a radioactive isotope or target material that is to become radioactive. In one or more illustrative examples, the inert metal oxide objects can be infused with neptunium and later converted to plutonium. In still other examples, a beta emitter can be infused in the inert metal oxide objects. In these instances, the inert metal oxide objects can comprise a low-z matrix. For example, the inert metal oxide objects can comprise an aluminum oxide. In this way, the dispersion of the beta emitters can be at least substantially uniform and the beta emissions can be absorbed in the low-z material. In various examples, the inert metal oxide objects can be comprised of a refractory matrix. To illustrate, the inert metal oxide objects can be comprised of an aluminum oxide or a zirconium oxide. In these scenarios, the inert metal oxide objects can be infused with heat-producing isotopes such as plutonium-238 (Pu-238).

In these scenarios, the production of the inert solid oxide objects using the sol-gel processes 106 can take place in a non-radiological environment to reduce the cost of producing radioactive isotope-containing objects, simplify waste operations, and improve safety in relation to existing sol-gel processes that use a feed solution that includes the radioactive material and requires radioactive material handling procedures and disposal operations. In various examples, by producing the inert metal oxide objects using a sol-gel process prior to infusion of the inert metal oxide objects with radioactive isotope materials, the solutions and equipment used to produce the inert metal oxide objects can be disposed of without having to comply with radiological waste requirements. Infusing the radioactive material into the inert solid oxide objects can also decrease the releasability of the radioactive material in the case of expose of the infused metal oxide object to the environment. The use of a low z material, such as an aluminum oxide, for infusing the radioactive material can cause absorption of beta radiation emissions and decrease bremsstrahlung production. The inert metal oxide objects also provide a more thermally conductive and refractory matrix material than existing radioactive containing materials that simply comprise an oxide of a radioactive isotope.

The process 100 can also include, at 110, performing one or more second processes with respect to the metal oxide objects 104 to produce functionalized objects 112. In one or more examples, the metal oxide objects 104 can be combined with one or more solutions that can produce functional groups on the surfaces of the functionalized objects 112. In at least some examples, the one or more second processes performed, at 112, can include one or more surface preparation processes and one or more functionalization processes. In one or more illustrative examples, the functional groups can include nitrogen-containing functional groups. In one or more additional illustrative examples, the functional groups disposed on the surfaces of the functionalized objects 112 can include amine groups. The addition of functional groups to the surfaces of the metal oxide objects 104 to produce the functionalized objects 112 can provide a foundation for producing a coating around the metal oxide objects 104.

At 114, the process 100 can include performing one or more third processes to produce metal coated objects 116. The one or more third processes can include combining the functionalized objects 112 with one or more solutions that include one or more metal precursors. In one or more examples, the one or more metal precursors can comprise a metal chloride. In one or more additional examples, the one or more metal precursors can comprise metal hexacarbonyl complex. In one or more further examples, the one or more metal precursors can comprise a metal acetylacetonate complex. In one or more illustrative examples, the one or more metal precursors can comprise platinum (Pt) to produce a platinum metal coated objects 116. In one or more additional illustrative examples, the one or more metal precursors can comprise palladium (Pd) to produce palladium metal coated objects 116. In one or more further illustrative examples, the one or more metal precursors can comprise iridium (Ir) to produce iridium metal coated objects 116. In still other examples, the one or more metal precursors can comprise tungsten (W) to produce tungsten metal coated objects 116. In various examples, the one or more metal precursors can comprise rhenium (Re) to produce rhenium metal coated objects 116. In one or more scenarios, the one or more metal precursors can comprise rhodium (Rh) to produce rhodium metal coated objects 116. In one or more instances, the one or more metal precursors can comprise ruthenium (Ru) to produce ruthenium metal coated objects 116. In one or more situations, the metal precursor can comprise tantalum (Ta) to produce tantalum metal coated objects 116. The one or more metal precursors can also include molybdenum (Mo) to produce molybdenum metal coated objects 116. Additionally, the one or more metal precursors can include titanium (Ti) to produce titanium metal coated objects 116.

In one or more examples, metal coated objects 116 can include a metal oxide core comprising the metal oxide objects 104 and one or more coating layers 118 formed from the one or more metal precursors used in the one or more third processes performed at 114. In various examples, the one or more coating layers 118 can comprise a single metallic material. In one or more additional examples, the one or more coating layers 118 can comprise multiple layers with individual layers comprised of different metallic materials. For example, the one or more coating layers 118 can include a first coating layer disposed over the metal oxide objects 104 comprised of iridium and a second coating layer disposed over the first coating layer comprised of platinum. In addition, the one or more coating layers 118 can include a first coating layer disposed over the metal oxide objects 104 comprised of iridium and a second coating layer disposed over the first coating layer comprised of palladium.

In one or more illustrative examples, the one or more coating layers 120 can comprise one or more alloys. In situations where the one or more coating layers 120 comprise a layer including an alloy, the alloy can include a platinum/rhodium alloy. Additionally, the alloy can include an iridium/tungsten alloy. Further, the alloy can include a rhenium/tungsten alloy. In still other examples, the alloy can include a molybdenum/rhenium alloy.

The one or more coating layers 120 can individually have a thickness of at least about 2 microns, at least about 5 microns, at least about 8 microns, at least about 10 microns, at least about 12 microns, or at least about 15 microns. In one or more additional examples, the one or more coating layers 120 can individually have a thickness no greater than about 30 microns, no greater than about 28 microns, no greater than about 25 microns, no greater than about 22 microns, or no greater than about 20 microns. In one or more illustrative examples, the one or more coating layers 120 can individually have a thickness from about 2 microns to about 30 microns, from about 2 microns to about 5 microns, from about 2 microns to about 10 microns, from about 2 microns to about 15 microns, from about 2 microns to about 20 microns, from about 5 microns to about 10 microns, from about 5 microns to about 15 microns, from about 5 microns to about 20 microns, from about 5 microns to about 25 microns, from about 5 microns to about 30 microns, from about 10 microns to about 15 microns, from about 10 microns to about 20 microns, from about 10 microns to about 30 microns, or from about 20 microns to about 30 microns.

In situations where the coated metal objects 116 comprise radioactive isotopes, disposing the one or more coating layers on the metal oxide objects 104 can improve thermal conductivity of metal coated objects 116 in relation to existing containers for radioactive isotopes. For example, a metallic coating disposed around the metal oxide objects 104 can enable heat generated by the radioactive isotope included in the metal oxide objects 104 to be transferred into the environment more readily than if the metal coating was not present. The coated metal objects 116 also provide improved safety in relation to non-coated radioactive isotope-containing objects. To illustrate, any amount of radioactive emissions released into the environment can be minimized and the generation of radioactive dust particles is minimized or eliminated in situations where the coated metal objects 116 are subjected to vibrations or impact. Further, the coating on metal objects 116 can provide a corrosion barrier between the oxide fuel and the container storing the oxide fuel. As a result, the amount of precious metals, such as iridium or platinum, needed is reduced and may allow for more conventional materials to be used for storage containers for the oxide fuel.

The process 100 can include, at 120, storing or using the metal coated objects 116. In one or more examples, the metal coated objects 116 can comprise a radioisotope heat and power source. In these instances, energy derived from the metal coated objects 116 can be used to provide power for consumers, businesses, governmental organizations, research institutions, and other entities. In various examples, energy derived from the metal coated objects 116 can be used in space or maritime environments. The metal coated objects 116 can be stored in containers that minimize exposure of radioactive emissions to the environment during transport and/or when being used as a heat and power source. In various examples, the metal coated objects 116 can be stored in metallic structures that provide thermal conductive pathways for the heat generated by the metal coated objects 116.

In one or more additional examples, the metal coated objects 116 can be used as catalysts or as catalyst support for one or more chemical reactions. In various examples, the metal coated objects 116 can be used as catalysts or catalyst supports in fluid bed, fixed bed, and/or slurry catalytic reactions. In one or more illustrative examples, the metal coated objects 116 can be used as catalysts in petrochemical reactions. In one or more additional illustrative examples, the metal coated objects 116 can be used as catalysts in the conversion of harmful gases. For example, the metal coated objects 116 can be used as catalysts in gas purification reactions to convert harmful gases to CO₂, H₂O, and N₂. In one or more further illustrative examples, the metal coated objects 116 can be used as catalysts in chemical synthesis reactions. In one or more additional examples, the metal coated objects 116 can be used for regenerable catalysts because of the ability to be used in relatively high temperature situations.

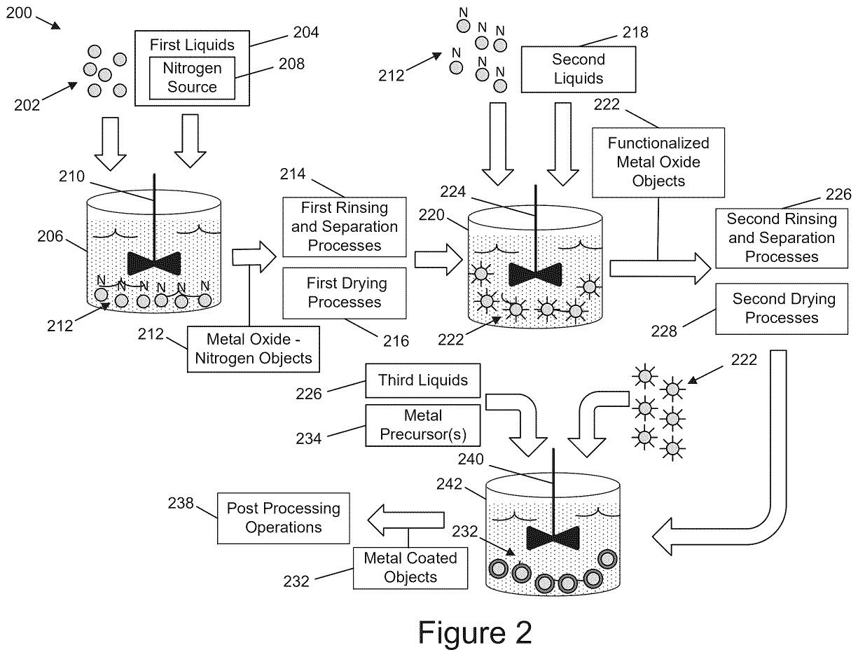

FIG. 2 illustrates a process 200 to produce amine functionalized metal oxide-containing objects and to form metal coated metal-oxide containing objects, in accordance with one or more example implementations. The process 200 can include combining metal oxide objects 202 with one or more first liquids 204 in a container 206. In one or more examples, the metal oxide objects 202 can be comprised of a metal oxide material that includes at least one of a transition metal, a lanthanide, an actinide. or aluminum. In one or more examples, the metal oxide objects 202 can be comprised of a plurality of metal oxides with individual metal oxides of the plurality of metal oxides being comprised of at least one of a transition metal oxide, a lanthanide oxide, or an actinide oxide. A volume of the container 206 can be from the milliliter scale to the liter scale or more.

In various examples, the metal oxide objects 202 can be comprised of a metal oxide that includes a radioactive isotope. In at least some examples, the metal oxide objects 202 can include a metal oxide material that emits at least one of alpha particles, beta particles, or gamma rays. In one or more illustrative examples, the metal oxide objects 202 can include at least one of Al₂O₃, SrTiO₃, AmO₂, CeO₂, PuO₂, UO₂, or U₃O₈. In addition, the metal oxide objects 202 can be comprised of materials that act as catalysts for one or more chemical reactions. In these instances, the metal oxide objects 202 can be comprised of at least one of Al₂O₃, Y₂O₃, Ce₂O₃, ZrO₂. In still other examples, the metal oxide objects 202 can be comprised of at least one of one or more oxides of scandium (Sc), one or more oxides of titanium (Ti), or one or more oxides of iron (Fe).

The metal oxide objects 202 can have a spherical shape. In one or more illustrative examples, the metal oxide objects 104 can have diameters from about 1 micron to about 20 microns, from about 20 microns to about 50 microns, from about 20 microns to about 200 microns, from about 50 microns to about 500 microns, from about 100 microns to about 500 microns, microns, from about 100 microns to about 1000 microns, from about 100 microns to about 2000 microns, from about 400 microns to about 800 microns, from about 400 microns to about 2000 microns, from about 800 microns to about 2000 microns, or from about 1200 microns to about 2000 microns.

In one or more examples, the metal oxide objects 202 can be produced by one or more sol-gel processes. For example, the metal oxide objects 202 can be produced by at least a portion of the implementations described with respect to the sol-gel processes 106 of FIG. 1. In one or more illustrative examples, the metal oxide objects 202 can be produced by implementing at least a portion of the techniques described in portion of the techniques described in Katalenich, J. A. 2017. “Production of cerium dioxide microspheres by an internal gelation sol-gel method.” Journal of Sol-Gel Science and Technology 82 (3): 654-663, and/or at least a portion of the techniques described in Katalenich, J. A., B. B. Kitchen, and B. D. Pierson. 2018. “Production of monodisperse cerium oxide microspheres with diameters near 100 μm by internal-gelation sol-gel methods.” Journal of Sol-Gel Science and Technology 86 (2): 329-342. In at least some examples, the metal oxide objects 202 can correspond to the metal objects 104 described in relation to FIG. 1.

The one or more first liquids 204 can comprise an aqueous solution. Additionally, the first liquids 204 can include a nitrogen source 208. In one or more examples, the nitrogen source 208 can comprise ammonium hydroxide. In one or more illustrative examples, the first liquids 204 can comprise a solution including water combined with an ammonium hydroxide solution. The ammonium hydroxide solution can have a molarity from 13 M to 16 M, from 13 M to 15 M, from 14 M to 16 M, or from 14 M to 15 M. The amount of an ammonium hydroxide solution included in the container 206 can be from about 10% to about 30% by volume of the first liquids 204, from about 10% to about 20% by volume of the first liquids 204, from about 15% to about 30% by volume of the first liquids 204, from about 15% to about 25% by volume of the first liquids 204, or from about 20% to about 30% by volume of the first liquids 204. In addition, the amount of water included in the container 206 can be from about 50% by volume to about 90% by volume of the first liquids 204, from about 50% by volume to about 80% by volume of the first liquids 204, from about 50% by volume to about 70% by volume of the first liquids 204, from about 60% by volume to about 90% by volume of the first liquids 204, from about 60% by volume to about 80% by volume of the first liquids 204, from about 70% by volume to about 90% by volume of the first liquids 204, or from about 70% by volume to about 80% by volume of the first liquids 204. In one or more illustrative examples, the first liquids 204 can include a nitrogen source 208 including a 14.5 M to 15 M ammonium hydroxide solution that comprises from about 15% by volume to about 25% by volume of the first liquids 204 and water from about 75% by volume to about 85% by volume of the first liquids 204.

The amount of the metal oxide objects 202 included in the container 206 with the first liquids 204 can comprise no greater than about 5% by weight of the combined weight of the first liquids and the metal oxide objects 202, no greater than about 3% by weight of the combined weight of the first liquids 204 and the metal oxide objects 202, or no greater than about 1% by weight of the combined weight of the first liquids 204 and the metal oxide objects 202. In one or more illustrative examples, the amount of metal oxide objects 202 included in the container 206 with the first liquids can comprise from about 0.5% by weigh to about 5% by weight of the combined weight of the first liquids 204 and the metal oxide objects 202, from about 1% by weight to about 3% by weight of the combined weight of the first liquids 204 and the metal oxide objects 202, from about 0.5% by weight to about 1.5% by weight of the combined weight of the first liquids 204 and the metal oxide objects 202, from about 1% by weight to about 2% by weight of the combined weight of the first liquids 204 and the metal oxide objects 202, from about 1.5% by weight to about 2.5% by weight of the combined weight of the first liquids 204 and the metal oxide objects 202, or from about 2% by weight to about 3% by weight of the combined weight of the first liquids 204 and the metal oxide objects 202.

In various examples, a mixing device 210 can be coupled to or otherwise associated with the first container 206. The mixing device 210 can include at least one of a mechanical mixing device or a sonic mixing device. In one or more illustrative examples, the mixing device 210 can include a mechanical stir bar, a paddle, or a sonicator. The mixing device 210 can provide mixing of the first liquids 204 and the metal oxide objects 202. In one or more illustrative examples, the mixing device 210 can operate at speeds from about 50 revolutions per minute (RPM) to about 400 RPM, from about 50 RPM to about 300 RPM, from about 50 RPM to about 250 RPM, from about 50 RPM to about 200 RPM, from about 50 RPM to about 150 RPM, from about 100 RPM to about 400 RPM, from about 100 RPM to about 300 RPM, from about 100 RPM to about 200 RPM, from about 150 RPM to about 400 RPM, from about 150 RPM to about 300 RPM, from about 150 RPM to about 250 RPM, from about 200 RPM to about 400 RPM, or from about 200 RPM to about 300 RPM. or from about 400 RPM to about 600 RPM.

In one or more additional illustrative examples, the mixing device 210 can operate from about 1 hour to about 15 hours, from about 2 hours to about 12 hours, from about 5 hours to about 15 hours, from about 5 hours to about 10, from about 1 hour to about 5 hours, from about 1 hour to about 3 hours, from about 2 hours to about 4 hours, from about 3 hours to about 5 hours, from about 4 hours to about 6 hours, from about 5 hours to about 7 hours, from about 6 hours to about 8 hours, from about 7 hours to about 9 hours, or from about 8 hours to about 10 hours. The first liquids 204 can be mixed in the container 206 at temperatures from about 15° C. to about 35° C., from about 20° C. to about 30° C., or from about 25° C. to about 35° C. The combining of the first liquids 204 in the container 206 can form metal oxide-nitrogen objects 212. In at least some examples, the metal oxide-nitrogen objects 212 can comprise nitrogen atoms coupled to surfaces of the metal oxide objects 202.

The metal oxide-nitrogen objects 212 can be subjected to first rinsing and separation processes 214. In one or more examples, the metal oxide-nitrogen objects 212 can subjected to one or more water rinses. In at least some examples, the metal oxide-nitrogen objects 212 can also be subjected to one or more centrifugation processes or one or more other separation processes. The first rinsing and separation processes 214 can be performed in the container 206, in various examples, In one or more additional examples, the first rinsing and separation processes 214 can be performed in one or more additional containers or other pieces of equipment suitable to perform the first rinsing and separation processes 214.

In addition, after performing the first rinsing and separation processes 214 with respect to the metal oxide-nitrogen objects 212, the metal oxide-nitrogen objects 212 can be subjected to one or more first drying processes 216. The one or more first drying processes 216 can include heating the rinsed metal oxide-nitrogen objects 212 at temperatures from about 80° C. to about 200° C., from about 90° C. to about 180° C., or from about 100° C. to about 150° C. The one or more first drying processes 216 can be performed for a duration from about 10 minutes to about 3 hours, from about 20 minutes to about 120 minutes, from about 20 minutes to about 90 minutes, from about 20 minutes to about 60 minutes, from about 20 minutes to about 40 minutes, from about 30 minutes to about 120 minutes, from about 30 minutes to about 90 minutes, from about 30 minutes to about 60 minutes, from about 45 minutes to about 120 minutes, or from about 45 minutes to about 90 minutes. In one or more illustrative examples, the one or more first drying processes 216 can be performed in a convection environment.

The process 200 can also include combining the metal oxide-nitrogen objects 212 with second liquids 218 in a container 220. In at least some examples, the container 220 can be the container 206. In one or more additional examples, the container 220 can be different from the container 206. A volume of the container 220 can be from the milliliter scale to the liter scale or more. Combining the metal oxide-nitrogen objects 212 with the second liquids 218 can produce functionalized metal oxide objects 222. The functionalized metal oxide objects 222 can include functional groups disposed on the surfaces of the metal oxide objects 202. The functional groups disposed on the surfaces of the metal oxide objects 202 can be used to form metallic coatings on the metal oxide objects 202.

The second liquids 218 can comprise one or more organic solvents. For example, the second liquids 218 can comprise one or more alcohols. In one or more illustrative examples, the second liquids 218 can comprise methanol. The second liquids 218 can also comprise a surface modification solution. In various examples, the surface modification solution included in the second liquids 218 can comprise (3-aminopropyl) trimethoxysilane (APTMS). In one or more illustrative examples, the surface modification solution can comprise from about 90% by weight to about 99% by weight APTMS. The amount of the surface modification solution included in the container 220 can be no greater than about 0.0005% by volume of the second liquids 218, no greater than about 0.0001% by volume, or no greater than about 0.00005% by volume of the second liquids 218, Additionally, the amount of one or more organic solvents included in the container 220 can be at least 95% by volume, at least 98% by volume, at least 99% by volume, or at least 99.9999% by volume of the second liquids 218. Further, the amount of the metal oxide-nitrogen objects 212 included in the container can be no greater than about 0.2% by weight of the combined weight of the second liquids 218 and metal oxide-nitrogen objects 212, no greater than about 0.1% by weight of the combined weight of the second liquids 218 and metal oxide-nitrogen objects 212, no greater than about 0.05% by weight of the combined weight of the second liquids 218 and metal oxide-nitrogen objects 212, or no greater than about 0.01% by weight of the combined weight of the second liquids 218 and metal oxide-nitrogen objects 212

In various examples, a mixing device 224 can be coupled to or otherwise associated with the container 220. The mixing device 224 can include at least one of a mechanical mixing device or a sonic mixing device. In one or more illustrative examples, the mixing device 224 can include a mechanical stir bar, a paddle, or a sonicator. The mixing device 224 can provide mixing of the second liquids 218 and the metal oxide-nitrogen objects 212. In one or more illustrative examples, the mixing device 224 can operate at speeds from about 50 revolutions per minute (RPM) to about 400 RPM, from about 50 RPM to about 300 RPM, from about 50 RPM to about 250 RPM, from about 50 RPM to about 200 RPM, from about 50 RPM to about 150 RPM, from about 100 RPM to about 400 RPM, from about 100 RPM to about 300 RPM, from about 100 RPM to about 200 RPM, from about 150 RPM to about 400 RPM, from about 150 RPM to about 300 RPM, from about 150 RPM to about 250 RPM, from about 200 RPM to about 400 RPM, or from about 200 RPM to about 300 RPM. or from about 400 RPM to about 600 RPM.

In one or more additional illustrative examples, the mixing device 224 can operate from about 1 hour to about 30 hours, from about 2 hours to about 25 hours, from about 5 hours to about 25 hours, from about 5 hours to about 20 hours, from about 5 hours to about 15 hours, from about 10 hours to about 30 hours, from about 10 hours to about 30 hours, from about 10 hours to about 20 hours, from about 15 hours to about 25 hours, or from about 20 hours to about 30 hours. The second liquids 218 can be mixed in the container 220 at temperatures from about 15° C. to about 35° C., from about 20° C. to about 30° C., or from about 25° C. to about 35° C. The combining of the second liquids 218 in the container 220 can form the functionalized metal oxide objects 222. In at least some examples, the functionalized metal oxide objects 222 can comprise amine functional groups coupled to surfaces of the metal oxide objects 202. In one or more illustrative examples, the functionalized metal oxide objects 222 can correspond to the functionalized metal oxide objects 112 described in relation to FIG. 1.

The functionalized metal oxide objects 222 can be subjected to second rinsing and separation processes 226. In one or more examples, the functionalized metal oxide objects 222 can subjected to one or more water rinses. The second rinsing and separation processes 226 can be performed in the container 220, in various examples, In one or more additional examples, the second rinsing and separation processes 226 can be performed in one or more additional containers or other pieces of equipment suitable to perform the second rinsing and separation processes 226. In one or more illustrative examples, at least a portion of the second rinsing and separation processes 226 can be optional.

In addition, the functionalized metal oxide objects 222 can be subjected to one or more second drying processes 228. The one or more second drying processes 228 can include heating the functionalized metal oxide objects 222 at temperatures from about 80° C. to about 200° C., from about 90° C. to about 180° C., or from about 100° C. to about 150° C. The one or more second drying processes 228 can be performed for a duration from about 10 minutes to about 3 hours, from about 20 minutes to about 120 minutes, from about 20 minutes to about 90 minutes, from about 20 minutes to about 60 minutes, from about 20 minutes to about 40 minutes, from about 30 minutes to about 120 minutes, from about 30 minutes to about 90 minutes, from about 30 minutes to about 60 minutes, from about 45 minutes to about 120 minutes, or from about 45 minutes to about 90 minutes. In one or more illustrative examples, the one or more second drying processes 228 can be performed in a convection environment.

The process 200 can also include combining the functionalized metal oxide objects 222 with third liquids 236 in a container 240. In at least some examples, the container 240 can be the container 206 or the container 220. In one or more additional examples, the container 240 can be different from at least one of the container 206 or the container 220. A volume of the container 240 can be from the milliliter scale to the liter scale or more. Combining the functionalized metal oxide objects 222 with the third liquids 236 can produce coated metal oxide objects 232. The coated metal objects 232 can include one or more metallic layers disposed on the surfaces of the metal oxide objects 202.

The third liquids 236 can comprise a solution that includes ethylene glycol. In one or more examples, the ethylene glycol can be combined with potassium hydroxide. In various examples, the potassium hydroxide can be added to an ethylene glycol solution and the mixture can be mixed until the potassium hydroxide has dissolved in the ethylene glycol. A combined ethylene glycol and potassium hydroxide solution can have no greater than about 1% by weight potassium hydroxide for a combined weight of ethylene glycol and potassium hydroxide, no greater than about 0.8% potassium hydroxide by weight of the combined weight of the second liquids 218 and metal oxide-nitrogen objects 212, no greater than about 0.5% by weight potassium hydroxide by weight of the combined weight of the second liquids 218 and metal oxide-nitrogen objects 212, or no greater than about 0.2% by weight potassium hydroxide by weight of the combined weight of the second liquids 218 and metal oxide-nitrogen objects 212. In at least some examples, the third liquids 236 can include an ionic salt. For example, the third liquids 236 can include 1-butyl-3-methylimidazoliumtetrafluoroborate (BMIM-BF₄).

In addition to the third liquids 236 and the functionalized metal oxide objects 222, one or more metal precursors 234 can be added to the container 240. The one or more metal precursors 234 can comprise at least one of one or more platinum precursors, one or more palladium precursors, one or more iridium precursors, one or more tungsten precursors, one or more rhenium precursors, one or more rhodium precursors, one or more ruthenium precursors, one or more tantalum precursors, one or more molybdenum precursors, or one or more titanium precursors. In one or more examples, the one or more metal precursors 234 can comprise a metal chloride. For example, the one or more metal precursors 234 can comprise at least one of platinum (II) chloride (PtCl₂), palladium (II) chloride (PdCl₂), iridium (III) chloride (IrCl₃), rhenium (III) chloride (ReCl₃), ruthenium (III) chloride (RuCl₃), tantalum (V) chloride (TaCl₅), molybdenum (IV) chloride (MoCl₄), or titanium (IV) chloride (TiCl₄). In one or more additional examples, the one or more metal precursors 234 can comprise a metal acetylacetonate. To illustrate, the one or more metal precursors 234 can include at least one of platinum acetylacetonate (Pt Acac) or rhodium acetylacetonate (Rh Acac). In still other examples, the one or more metal precursors 234 can include tungsten hexacarbonyl (W(CO)₆).

Combining the functionalized metal oxide objects 222, the third liquids 236, and the one or more metal precursors 234 can produce a mixture in the container 240. The mixture can be comprised of at least about 90% by weight ethylene glycol, at least about 92% by weight ethylene glycol, at least about 95% by weight ethylene glycol, or at least about 99% by weight ethylene glycol. The mixture can also comprise no greater than about 1% by weight individually of potassium hydroxide, the one or more metal precursors 234, the functionalized metal oxide objects 222, and BMIM-BF₄. In one or more additional examples, a ratio of the amount of the one or more metal precursors 234 to the amount of the functionalized metal oxide objects 222 can be from about 0.5:1-1:1, from about 0.5:1-1.5:1, from about 0.7:1 to about 1.2:1, from about 0.5:1 to about 0.8:1, from about 1:1 to about 1.5:1, from about 1.5:1 to about 2:1, from about 2:1 to about 2.5:1, or from about 1:1 to about 2:1.

In various examples, a mixing device 242 can be coupled to or otherwise associated with the container 240. The mixing device 242 can include at least one of a mechanical mixing device or a sonic mixing device. In one or more illustrative examples, the mixing device 242 can include a mechanical stir bar, a paddle, or a sonicator. The mixing device 242 can provide mixing of the third liquids 236, the one or more metal precursors 234, and the functionalized metal oxide objects 222. In one or more illustrative examples, the mixing device 242 can operate at speeds from about 100 revolutions per minute (RPM) to about 500 RPM, from about 100 RPM to about 400 RPM, from about 100 RPM to about 300 RPM, from about 100 RPM to about 250 RPM, from about 100 RPM to about 200 RPM, from about 200 RPM to about 400 RPM, from about 200 RPM to about 300 RPM, from about 250 RPM to about 350 RPM, or from about 300 RPM to about 400 RPM.

In one or more additional illustrative examples, the mixing device 242 can operate from about 5 minutes to about 2 hours, from about 20 minutes to about 1 hour, from about 10 minutes to about 30 minutes, from about 20 minutes to about 40 minutes, from about 30 minutes to about 50 minutes, or from about 40 minutes to about 60 minutes. The third liquids 236, the one or more metal precursors 234, and the functionalized metal oxide objects 222 can be mixed in the container 240 at temperatures from about 800° C. to about 190° C., from about 100° C. to about 150° C., or from about 150° C. to about 190° C.

The combining of the third liquids 236, the one or more metal precursors 234, and the functionalized metal oxide objects 222 can form the metal coated objects 232. The metal coated objects 232 can include one or more metallic coating layers encasing the metal oxide objects 202. The one or more metallic coating layers can individually have a thickness from about 2 microns to about 30 microns, from about 2 microns to about 5 microns, from about 2 microns to about 10 microns, from about 2 microns to about 15 microns, from about 2 microns to about 20 microns, from about 5 microns to about 10 microns, from about 5 microns to about 15 microns, from about 5 microns to about 20 microns, from about 5 microns to about 25 microns, from about 5 microns to about 30 microns, from about 10 microns to about 15 microns, from about 10 microns to about 20 microns, from about 10 microns to about 30 microns, or from about 20 microns to about 30 microns.

In scenarios where multiple metallic layers are disposed on the metal oxide objects 202, a first metallic layer can be formed on the metal oxide objects 202 by performing a first iteration of the process 200. After the first iteration of the process and forming a first metallic layer on the metal oxide objects 202, the metal coated objects 232 can be subjected to one or more heat treatments. For example, the metal coated objects 232 can be heated at temperatures from about 150° C. to about 350° C., from about 200° C. to about 300° C., from about 150° C. to about 200° C., from about 200° C. to about 250° C., from about 250° C. to about 300° C., or from about 300° C. to about 350° C. for a duration from about 10 hours to about 100 hours, from about 10 hours to about 30 hours, from about 30 hours to about 50 hours, from about 50 hours to about 70 hours, or from about 70 hours to about 90 hours. Subsequent to the formation of a first metallic layer on the metal oxide objects 202, the process 200 can be repeated for form a second metallic layer on the first metallic layer to produce a metal coated object having a first metallic layer comprised of one or more first metals based on one or more first metal precursors and a second metallic layer comprised of one or more second metals based on one or more second metal precursors. One or more additional metallic layers can be formed on the metal coated objects by performing one or more additional iterations of the process 200.

Further, in situations where the metallic coating formed on the metal coated objects 232 comprised an alloy, the one or more metal precursors 234 can include a first metal salt corresponding to a first metal included in the metallic alloy coating formed on the metal coated objects 232 and a second metal salt corresponding to a second metal included in the metallic alloy coating formed on the metal coated objects 232. In one or more illustrative examples, the metallic coating formed on the metal oxide objects 202 can include an alloy comprising platinum and rhodium. In one or more additional illustrative examples, the metallic coating formed on the metal oxide objects 202 can include an alloy comprising iridium and tungsten. In one or more further illustrative examples, the metallic coating formed on the metal oxide objects 202 can include an alloy comprising rhenium and tungsten. In still other illustrative examples, the metallic coating formed on the metal oxide objects 202 can include an alloy comprising molybdenum and rhenium.

The metal coated objects 232 can be subjected to one or more post processing operations 238. The one or more post-processing operations 238 can include one or more cooling operations that comprise turning off a heating element that was being used to heat the mixture during mixing by the mixing device 242. The one or more post processing operations 238 can also include performing one or more rinsing operations with respect to the metal coated objects 232. In at least some examples, the one or more rinsing operations can be performed using water. Additionally, the post processing operations 238 can include performing one or more separation operations with respect to the metal coated objects 232. In one or more examples, the one or more separation operations can include performing one or more centrifugation operations. The one or more centrifugation operations can be performed at speed from about 3000 RPM to about 5000 RPM for a duration of about 30 minutes to about 5 minutes.

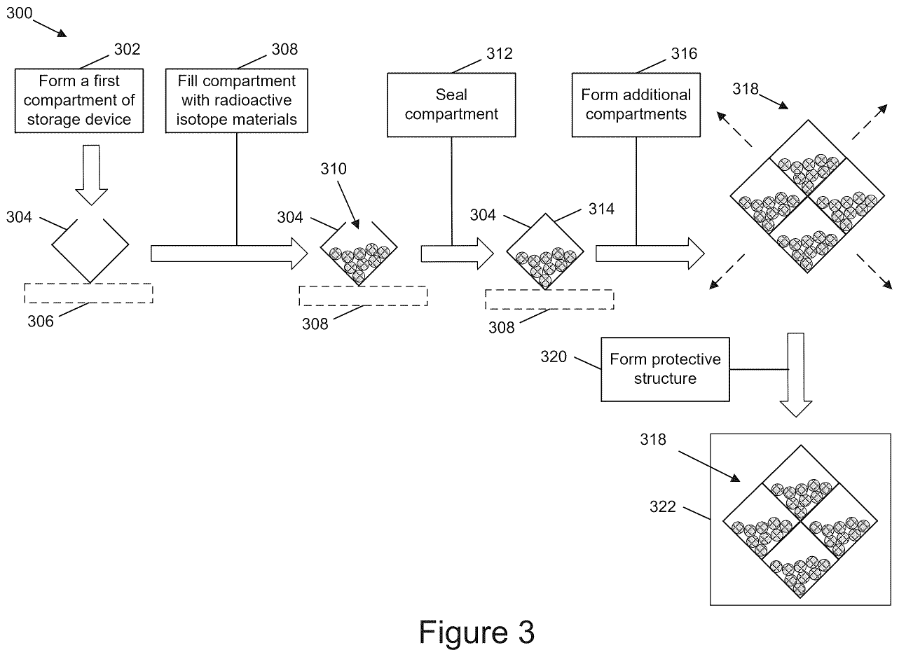

FIG. 3 illustrates a process 300 to produce first examples of a storage container for coated metal oxide-containing objects, in accordance with one or more example implementations. At 302, the process 300 can include forming a first compartment 304 of a storage device for radioisotope heat and power sources. In one or more examples, the first compartment 304 can be formed by an additive manufacturing process. In one or more illustrative examples, the additive manufacturing process can include an extrusion or fusion-based advanced manufacturing process. Fusion-based advanced manufacturing techniques using metals can include wire feed, powder bed wire arc, laser cladding, or electron beam cladding. In at least some examples, the first compartment 304 can be formed from one or more metallic materials. In various examples, the one or more metallic materials can be heated and formed according to a pattern that corresponds to a shape of the first compartment 304. Although the shape of the first compartment 304 in the illustrative example of FIG. 3 is a cubic shape, the first compartment 304 can have other shapes. In at least some examples, the first compartment 304 can have a polygonal shape. For example, the first compartment 304 can have a triangular shape. In one or more illustrative examples, the first compartment 304 can have a hexagonal shape. Additionally, the first compartment 304 can have an octagonal shape. In still other illustrative examples, the first compartment 304 can have a decagonal shape. In one or more further illustrative examples, the first compartment 304 can have a trapezoidal shape. In various examples, the first compartment 304 can have a spherical shape or an ellipsoidal shape. In a number of additional examples, the first compartment 304 can have a non-planar geometry. Non-planar geometry can include three-dimensional shapes with features that have out-of-plane characteristics.

The dimensions of individual sides of the compartment 304 can range from a scale of millimeters to centimeters. For example, individual sides of the compartment 304 can be from about 1 mm to about 100 mm, from about 1 mm to about 50 mm, from about 50 mm to about 100 mm, from about 1 mm to about 20 mm, from about 10 mm to about 30 mm, from about 20 mm to about 40 mm, from about 30 mm to about 50 mm, from about 40 mm to about 60 mm, from about 50 mm to about 70 mm, from about 60 mm to about 80 mm, from about 70 mm to about 90 mm, or from about 80 mm to about 100 mm. In various examples, individual sides of the first compartment 304 can have thicknesses from about 50 microns to about 10 mm, from about 100 microns to about 5 mm, from about 100 microns to about 500 microns, from about 500 microns to about 1 mm, from about 200 microns to about 400 microns, from about 300 microns to about 500 microns, from about 400 microns to about 600 microns, from about 500 microns to about 700 microns, from about 600 microns to about 800 microns, from about 700 microns to about 900 microns, or from about 800 microns to about 1 mm.

The sides of the first compartment 304 can be comprised of one or more metallic materials. For example, the sides of the first compartment 304 can be comprised of an aluminum-containing material or one or more alloys of aluminum. The sides of the first compartment 304 can also be comprised of a titanium material or one or more alloys of titanium. Additionally, the sides of the first compartment 304 can be comprised of an iron-containing material or one or more alloys of iron. Further, the sides of the first compartment 304 can be comprised of a niobium-containing materials. In still other examples, the sides of the first compartment 304 can be comprised of a tantalum-containing material. In one or more additional examples, the sides of the first compartment 304 can be comprised of a platinum-containing material. In one or more further examples, the sides of the first compartment 304 can be comprised of an iridium-containing material. The sides of the first compartment 304 can also be comprised of a nickel-containing material or a nickel alloy material. In various examples, the materials used to form the first compartment 304 are selected to withstand the amount of heat produced by objects stored within the first compartment 304. In one or more examples, the first compartment 304 can optionally be formed on a substrate 306. The substrate 306 can be comprised of one or more metallic materials, one or more polymeric materials, or one or more ceramic materials.

In scenarios where the first compartment 304 is formed using fusion-based metal advanced manufacturing techniques, the material used to form the first compartment 304 can be heated as the material is being extruded. In at least some examples, the material used to form the first compartment 304 can be heated above a melting point of the material during extrusion of the material. In one or more illustrative examples, the material used to form the first compartment 304 can be heated to temperatures from about 20° C. to about 600° C. above the melting point of the material, from about 50° C. to about 500° C. above the melting point of the material, from about 100° C. to about 400° C. above the melting point of the material, from about 20° C. to about 100° C. above the melting point of the material, from about 100° C. to about 250° C. above the melting point of the material, or from about 250° C. to about 500° C. above the melting point of the material.

At 308, the process 300 can include filling the first compartment 304 with a load 310. In one or more examples, the load 310 can include radioactive isotope materials. In one or more examples, the radioactive isotope materials of the load 310 can comprise the metal coated objects 116 described in relation to FIG. 1 and/or the metal coated objects 232 described in relation to FIG. 2. In various examples, the radioactive isotope materials of the load 310 can be dispensed from a hopper into the first compartment 304. In one or more additional examples, the load 310 can include one or more catalyst materials. In various examples, the objects included in the load 310 can be coated or uncoated. Additionally, although not shown in the illustrative example of FIG. 3, a number of additional objects comprised of inert materials can also be loaded in the compartment.

The process 300 can include, at 312, sealing the compartment 304. The compartment 304 can be sealed by adding a sealing component 314 to the compartment 304. In one or more examples, the sealing component 314 can comprise one or more of the same materials from which the remainder of the compartment 304 was formed. In at least some examples, the sealing component 314 can be formed by a same or similar additive manufacturing process as the additive manufacturing process used to form the compartment 304. In one or more illustrative examples, at least a portion of the sealing component 314 can comprise material that enables gas formed by the radioactive isotope materials of the load 310 to be vented outside of the compartment 304. In one or more additional examples, one or more vents can be placed at different locations of the compartment 304. In one or more illustrative examples, the one or more vents included in the compartment 304 can be formed such that gas exit the compartment 304, but the objects including the radioactive isotope material cannot pass through the one or more vents. In still other examples, although the sealing component 314 is shown being located at a specified location of the compartment 304, the sealing component 314 can be located at other parts of the compartment in one or more additional implementations.

At 316, the process 300 can include forming a number of additional compartments to produce a radioisotope heating and power source storage structure 318. The radioisotope heating and power source storage structure 318 can comprised a plurality of compartments that store radioactive isotope materials. The additional compartments of the radioisotope heating and power source storage structure 318 can be formed in a same or similar manner as the first compartment 304. In various examples, the radioisotope heating and power source storage structure 318 can store a plurality of different types of radioactive isotope materials. In at least some examples, the materials used to form different compartments included in the radioisotope heating and power source storage structure 318 can be different. For example, a compartment of the radioisotope heating and power source storage structure 318 storing a first type of radioactive isotope material can be formed from one or more first metallic materials and an additional compartment of the radioisotope heating and power source storage structure 318 storing a second type of radioactive isotope material can be formed from one or more second metallic materials.

In one or more examples, the additional compartments of the radioisotope heating and power source storage structure 318 can be formed according to a design or pattern. In one or more illustrative examples, the radioisotope heating and power source storage structure 318 can comprise a number of compartments on the order of tens, hundreds, or thousands. In one or more additional illustrative examples, the compartments included in the radioisotope heating and power source storage structure 318 can be arranged according to a pomegranate shaped design.

The process 300 can also include, at 320, forming a protective structure 322 around the radioisotope heating and power source storage structure 318. In one or more examples, the protective structure 322 can comprise a number of additional compartments corresponding to a size and/or shape of compartment 304. In one or more additional examples, the protective structure 322 can comprise one or more additional compartments having sizes and/or shapes that are different from the compartment 304. In at least some examples, the protective structure 322 can be formed from one or more materials that are different from the one or more materials used to form the radioisotope heating and power source storage structure 318. The protective structure 322 can be designed and manufactured to reduce or minimize the release of radioactive isotope materials from the radioisotope heating and power source storage structure 318 during transportation of the radioisotope heating and power source storage structure 318 and/or in situations where the radioisotope heating and power source storage structure 318 is impacted by one or more additional objects. In one or more illustrative examples, the impact can occur following atmospheric re-entry onto an unyielding surface.

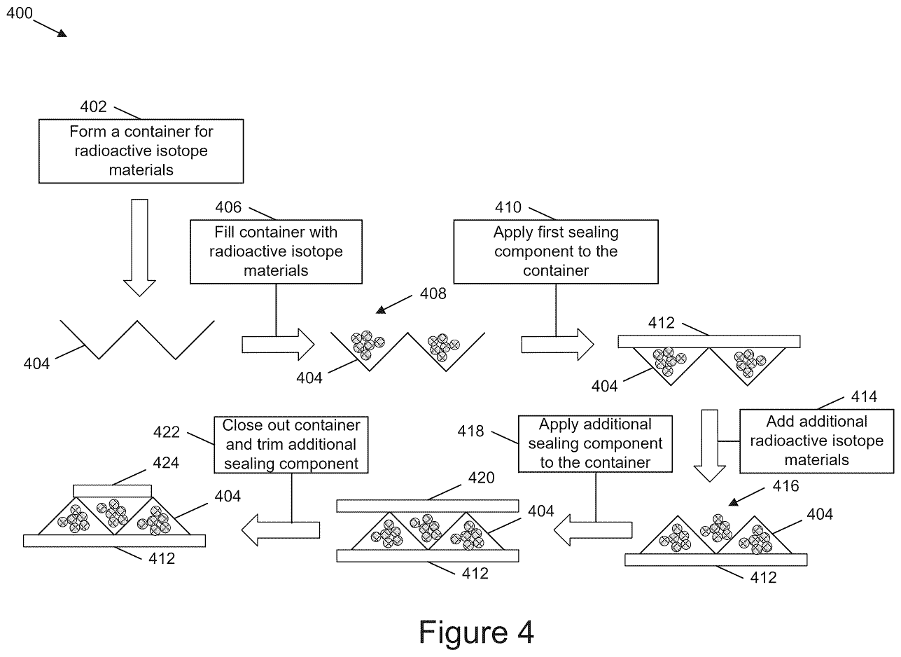

FIG. 4 illustrates a process 400 to produce second examples of a storage container for coated metal oxide-containing objects, in accordance with one or more example implementations. At 402, the process 400 can include forming a container 404 for radioactive isotope materials. The container 404 can be produced by bending or otherwise forming a sheet comprised of one or more metallic materials into a specified shape. In one or more examples, the container 404 can be comprised of an aluminum-containing material or one or more alloys of aluminum. The container 404 can also be comprised of a titanium material or one or more alloys of titanium. Additionally, the container 404 can be comprised of an iron-containing material or one or more alloys of iron. Further, the container 404 can be comprised of a niobium-containing materials. In still other examples, the container 404 can be comprised of a tantalum-containing material. In one or more additional examples, the container 404 can be comprised of a platinum-containing material. In one or more further examples, the container 404 can be comprised of an iridium-containing material. In still other examples, the container 404 can be comprised of a nickel-containing material or a nickel alloy material. In various examples, the materials used to form the container 404 are selected to withstand the amount of heat produced by objects stored within the container 404. In these scenarios, the materials used to form the container 404 can be comprised of high temperature, non-corrosive alloys.

At 406, the process 400 can include filling the container 404 with radioactive isotope materials 408. In various examples, the radioactive isotope materials 408 can comprise the metal coated objects 116 described in relation to FIG. 1 and/or the metal coated objects 232 described in relation to FIG. 2. In various examples, the radioactive isotope materials 408 can be dispensed from a hopper into the container 404. Additionally, although not shown in the illustrative example of FIG. 4, a number of additional objects comprised of inert materials can also be disposed in the compartment.

The process 400 can include, at 410, applying a first sealing component 412 to the container 404. In one or more examples, the first sealing component 412 can comprise a sheet comprised of one or more metallic materials. In various examples, the first sealing component 412 can be comprised of one or more of the same materials as the container 404. In one or more illustrative examples, the first sealing component 412 can be attached to the container 404 by one or more welding processes. At 414, the process 400 can include adding additional radioactive isotope materials to the container 404. In various examples, the container 404 can be flipped before adding the additional radioactive isotope materials.

Additionally, the process 400 can include, at 418, applying an additional sealing component 420 to the container 404. The additional sealing component 420 can comprise a sheet comprised of one or more metallic materials. In various examples, the additional component 420 can be comprised of one or more of the same materials as the container 404. In one or more illustrative examples, the additional sealing component 420 can be attached to the container 404 by one or more welding or joining processes. Further, the process 400 can include, at 422, closing out the container 404 and trimming the additional sealing component 420 to produce a modified sealing component 424 for a closed container 426. In one or more examples, additional closed containers can be produced using the process 400 and attached to the closed container 426 to form a larger radioisotope heat and power source storage container. In one or more illustrative examples, a plurality of closed containers 426 can be arranged in a honeycomb pattern.

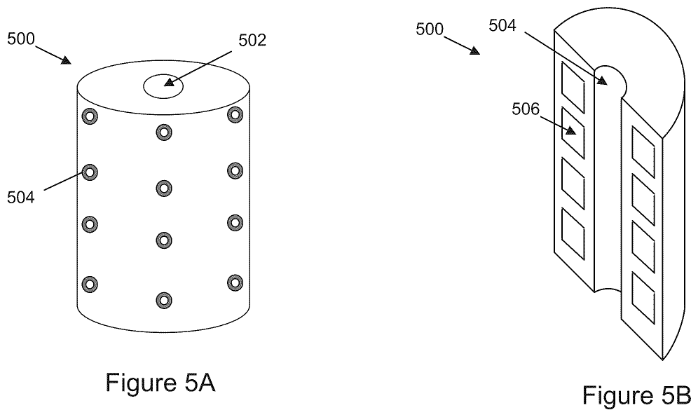

FIG. 5A illustrates a third example of a storage container 500 for metal oxide-containing objects, in accordance with one or more example implementations. The storage container 500 can include a number of compartments for storing radioisotope heat sources. In one or more examples, the radioisotope heat sources stored by the storage container 500 can comprise the metal coated objects 116 described in relation to FIG. 1 and/or the metal coated objects 232 described in relation to FIG. 2. The storage container 500 can be comprised of one or more refractory materials. In one or more illustrative examples, the storage container 500 can be comprised of a niobium-containing materials. In still other examples, the storage container 500 can be comprised of a tantalum-containing material. In one or more additional examples, the storage container 500 can be comprised of a platinum-containing material. In one or more further examples, the storage container 500 can be comprised of an iridium-containing material. In still other examples, the storage container 500 can be comprised of a nickel-containing material or a nickel alloy material. In various examples, the materials used to form the storage container 500 are selected to withstand the amount of heat produced by objects stored within the storage container 500. In these scenarios, the materials used to form the storage container 500 can be comprised of high temperature, non-corrosive alloys. In various examples, the storage container 500 can be produced using one or more additive manufacturing techniques. In at least some examples, the storage container 500 can be produced using one or more powder bed fusion additive manufacturing techniques.

The storage container 500 can be formed to include a hole 502 that can hold a thermally conductive material such as a heat pipe. Additionally, the storage container 500 can be formed to include a number of vents 504. The vents 504 can be formed to enable gas produced by radioisotope fuel and power sources stored within the storage container 500 to flow out of the storage container 500. In at least some examples, prior to forming the vents 504, the holes that correspond to the locations of the vents 504 can be used to load individual compartments of the storage container 500 with the radioisotope heat and power sources.

FIG. 5B a cross-sectional view of the third example of a storage container 500 for coated metal oxide-containing objects, in accordance with one or more example implementations. The cross-sectional view of the storage container 500 shows individual compartments 506 formed within the storage container 500. In one or more examples, at least one vent 504 can correspond to an individual compartment 506.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1. An article comprising: a spherically shaped object comprising a metal oxide-containing material, the spherically-shaped object having a diameter from about 10 microns to about 1000 microns and the metal oxide-containing material including a lanthanide or an actinide; and a coating having a layer disposed on an outer surface of the spherically shaped object, the coating including at least 50% by weight of a metal selected from Ru, Ir, Pt, Rh, Pd, Ti, Ta, Mo, W and the coating having a thickness from about 2 micrometers to about 20 micrometers.

Example 2. The article of example 1, wherein the metal oxide-containing material is an alpha particle emitter or a beta particle emitter.

Example 3. The article of example 2, wherein the metal oxide-containing material includes Ce, Pu, U, Sr, or Am.

Example 4. The article of any one of examples 1-3, wherein the coating comprises an Ir-containing alloy that includes at least one of W, Th, Ce, or Mo.

Example 5. The article of any one of examples 1-3, wherein the coating comprises a Mo-containing alloy or a W-containing alloy that includes at least one of Re or HfC.

Example 6. The article of any one of examples 1-3, wherein the coating comprises a T-containing alloy or a Mo-containing alloy that includes at least one of Re, Hf, Zr, or C.

Example 7. The article of any one of examples 1-3, wherein the coating comprises a Pt-containing alloy that includes at least one of Rh or W.

Example 8. The article of any one of examples 1-7, comprising an additional coating comprising an additional layer disposed on the layer.

Example 9. The article of example 8, wherein the layer comprises Ir and the additional layer comprises Mo.

Example 10. The article of any one of examples 1-9 wherein the spherically shaped objects are infused with one or more radioactive isotopes.

Example 11. A method comprising: providing a number of spherically shaped objects comprising a metal oxide-containing material, the spherically-shaped object having a diameter from about 10 microns to about 1000 microns and the metal oxide-containing material including a lanthanide or an actinide; combining the number of spherically shaped objects into a container that comprises one or more first solutions to produce a number of functionalized objects, the number of functionalized objects having a plurality of instances of one or more functional groups coupled to surfaces of the number of functionalized objects; and combining the number of functionalized objects with one or more second solutions to produce a number of metal coated objects having one or more layers of a metallic coating encasing the number of spherically shaped objects, wherein the one or more second solutions include one or more metallic materials and the one or more layers of the metallic coating are comprised of the one or more metallic materials.

Example 12. The method of example 11, wherein the one or more functional groups comprise amine-containing functional groups.

Example 13. The method of example 12, first solutions comprising a nitrogen source to add nitrogen to surfaces of the number of spherically shaped objects and produce metal oxide nitrogen objects.

Example 14. The method of example 13, wherein the nitrogen source comprises an aqueous solution includes from about 10% by volume to about 30% by volume of a 13 molar to 16 molar ammonium hydroxide solution.

Example 15. The method of example 13, wherein the one or more first solutions include one or more additional solutions to convert the nitrogen atoms attached to the surfaces of the spherically shaped objects to the amine-containing functional groups.

Example 16. The method of example 15, wherein the one or more first solutions include (3-aminopropyl) trimethoxysilane (APTMS) to convert the nitrogen atoms attached to the surfaces of the spherically shaped objects to the amine-containing functional groups.

Example 17. The method of any one of examples 11-16, wherein the one or more second solutions comprise a potassium hydroxide and ethylene glycol solution and an amount of 1-butyl-3-methylimidazoliumtetrafluoroborate (BMIM-BF₄).

Example 18. The method of any one of examples 11-16, wherein the one or more second solutions are mixed with the functionalized objects at speeds from about 100 revolutions per minute (RPM) to about 500 RPM and heated at temperatures from about 100° C. to about 300° C.

Example 19. An article comprising: a body having a storage area comprising a plurality of compartments; the individual compartments of the plurality of compartments located adjacent to at least one additional compartment of the plurality of compartments, the individual compartments having a geometric shape; and the individual compartments being formed from a metallic material comprising at least one of titanium, iridium, platinum, nickel, a nickel alloy, or tantalum.

Example 20. The article of example 19, wherein: a protective structure is formed around the body; at least a portion of the individual compartments are configured to store radioisotope heating and power sources; and individual compartments of the plurality of compartments have sides with dimensions from about 1 millimeter (mm) to about 100 mm.

### Experimental Example

The ability to remove heat is paramount to nuclear fuel performance and longevity. Retaining fission product and separating fuel from reactor coolant and the environment is also necessary to prevent radiological contamination. Conventional nuclear fuel for commercial light water reactors and radioisotope power systems (RPS) is composed of oxide powders pressed into a pellet (cm-scale) and then sealed into a metal cladding to confine the fuel. What typical fuels lack is a method to surround each particle of nuclear fuel in metal, thus providing a more intimate protection layer for accident tolerance and boosting the thermal extraction from the fuel element. In such a way, metal-coated fuel particles increase heat extraction efficiency over clad-pellet designs while increasing the accident tolerance of the fuel. Metal oxide microspheres have wide-ranging applications, including the realm of fuels for nuclear reactors and RPS. Microspheres of uranium oxide/uranium carbide, mixed uranium/plutonium oxides, transuranics, and thorium fuels have been extensively studied. Pacific Northwest National Laboratory has also demonstrated the production of ²³⁸PuO₂ microspheres for RPS applications. Metal-coated oxide microsphere fuels may also be attractive for other applications such as nuclear thermal rockets, future nuclear reactor designs, and catalysts.

### Introduction

The ability to remove heat is paramount to nuclear fuel performance and longevity (Harp et al. 2015). Conventional nuclear fuel for commercial light water reactors and radioisotope power systems (RPS) is composed of oxide powders pressed into a pellet (cm-scale) and then sealed into a metal cladding to confine the fuel (Clark et al. 2007). What typical fuels lack is a method to surround each particle of nuclear fuel in metal, thus providing a more intimate protection layer for accident tolerance and boosting the thermal extraction from the fuel element. In such a way, metal-coated fuel particles increase heat extraction efficiency over clad-pellet designs while increasing the accident tolerance of the fuel. Metal oxide microspheres have wide-ranging applications, including the realm of fuels for nuclear reactors and RPS. Microspheres of uranium oxide/uranium carbide, mixed uranium/plutonium oxides, transuranics, and thorium fuels have been extensively studied. PNNL has also demonstrated the production of ²³⁸PuO₂ microspheres for RPS applications. Metal-coated oxide microsphere fuels may also be attractive for other applications such as nuclear thermal rockets and future nuclear reactor designs.

Sol-gel approaches are an attractive means to produce high-quality uniform microspheres for nuclear fuels (Katalenich et al. 2018). Internal gelation sol-gel methods (which create pure metal oxide spheres out of aqueous metal nitrate solutions) were originally developed to produce uranium oxide microspheres for advanced tri-structural isotropic (TRISO) nuclear fuels. Microspheres of uranium, thorium, and cerium oxides (as a surrogate for PuOₓ) (Arima et al. 2005) have all been successfully produced via sol-gel methods and continue to be studied for their applications to nuclear fuels (Brykala and Rogowski 2016; Maji et al. 2023; Suresh Kumar et al. 2003). These sol-gel methods are advantageous because solid gels are formed from aqueous solutions during internal gelation, causing final products to exhibit a homogeneous distribution of elements dissolved in the feed solution (J. A. Katalenich et al., 2018; J. Katalenich & Sholtis, 2021; Sawant et al., 2002; Vaidya et al., 1987). Sol-gel microsphere production is also essentially dust-free compared to traditional, powder-based fuel fabrication (Aegerter et al. 2011). In particular, recent studies of sol-gel CeOₓ production show excellent purity comparisons to commercial powder CeOₓ standards (Sökücü et al. 2015). Sol-gel microsphere fuels may be pressed into pellets or loaded into a cladding and vibro-compacted, but present challenges with heat conduction and dispersibility in an accident scenario. The addition of a noble metal coating alleviates these challenges by providing a thermally conductive barrier layer (Clavier et al. 2017; Hao et al. 2014; Katalenich and Sholtis 2021; Matthews and Hart 1980; Somayajulu 2017).

Related to sol-gel reduction for oxides is the polyol reduction for metals. Typically, this method is used to create engineered metal nanoparticles (Carroll et al. 2011; Fievet et al. 2018; Ma et al. 2016). It has been shown that with the use of functionalization (Park et al. 2006) the polyol method can be extended to coat oxide surfaces with nanometers to microns of metal (Hubbard 2016). By applying the functionalization and coating processes demonstrated (Hubbard 2016) with sol-gel proceeded fuels, we sought to demonstrate that each fuel particle can be coated in an inert metal. Specifically, we hypothesized that a 10-micron thick iridium-coated sphere of cerium oxide that has been fired in air to 1,000° C. for 2 hours will have only marginal (within the detection limit error) leakage of the cerium core when suspended in pure methanol at ambient temperatures for 72 hours. By showing that these coated cerium oxide particles do not dissolve when leach tested, we have demonstrated the individually coated fuel particles can be created by modification of the polyol process and that they have the potential to increase fuel accident tolerance and thermal extraction efficiency.

### Precious Metal Group Materials & Alloy Selection

For coated particles of an alpha-emitting thermal source, e.g., ²³⁸PuO₂, stopping alpha particles within 10 to 15 microns of the surface of the source can be accomplished with Ir or Pt. Iridium has the benefit of being more oxidation-resistant, having a higher thermal conductivity, and having greater strength. An additional layer of a lighter Mo-alloy, e.g., Mo-5% Re could also be applied.

For high-temperature nuclear reactor fuel, the coating must be compatible with whatever form will be used for the fuel: UO₂, UMo, UZr, UC, or UN. Uranium nitride is desirable for its higher thermal conductivity and low fission gas release; however, at very high temperature and with irradiation, free nitrogen becomes available and would chemically interact with the cladding. Rhenium (Re) has been proposed as a coating, but a precious metal group coating may also be applied, possibly to the ceramic fuel particles. The coating should be as thin as possible, and also be compatible with the cladding material, which would likely be a material with minimal parasitic neutron absorption (Klopp 1985).

For catalytic systems, the coatings may be a combination of precious group metals depending on the desired reaction. There would likely be a base material to provide a relatively large surface area, with a base catalyst, or a temperature-/corrosion-resistant coating, then an active catalyst of a given precious group metal or a combination of precious metal groups, e.g., Pt/Pd with Rh/Ru, depending on the desired synthesis.

Overall, the following rankings can be made:
Ranked by melting point: W, Re, Os, Ta, Mo, Nb, Ir
Ranked by thermal conductivity: W, Rh, Ir, Mo, Ru
Ranked by mechanical properties: W, Mo, Ir, Ru/Rh
Overall best primary element costing material: Ir (best for oxidation, thermal conductivity, and alpha range).

It is worth noting that tungsten and molybdenum must be alloyed with rhenium or other elements (Hf, Zr, C), and ruthenium and rhodium likely need alloying for improved mechanical properties. Optimal alloys for coating are application-specific.

### Thermophysical and Thermomechanical Properties of Reactive/Refractory and Precious Metal Group Metals

Selected thermophysical properties of candidate coating elements are provided in Table 1, including melting point (MP), density, thermal conductivity (kth), and the range of 5.6 MeV alpha particles in the metal. Transitional metallic elements in periods 4 (Table 1A), 5 (Table 1B), and 6 (Table 1C) of the periodic table, Groups 3 through 10, are included. The red-colored cells indicate primary elements not suitable for structural use; La and Mn have relatively low melting points and poor thermal conductivity, while Tc is a radioactive artificial element. The Group 3 elements have lower melting temperatures in their respective periods, as well as the lowest densities and generally low thermal conductivity. The light brown- and orange-colored cells indicate elements with lower melting points than other elements in their respective periods, and the green-colored cells indicate metals for potential application subject to temperature and other constraints. The dark green-colored cells show the three best elements for high-temperature applications: W, Mo, and Ir. These elements would most likely be alloyed for improved strength and creep resistance at high temperatures. Mo and W are typically alloyed with Re and fine particles of HfC for improved high-temperature strength and creep resistance, while Ir has been alloyed with W.

TABLE 1A
Thermophysical Properties of Transition Metals of Period
4 in Groups 3 through 10 in the Periodic Table

| Group | 3 | 4 | 5 | 6 | 7 | 8 | 9 | 10 |
|---|---|---|---|---|---|---|---|---|
| Element | Sc | Ti | V | Cr | Mn | Fe | Co | Ni |
| MP, ° C. | 1539 | 1667 | 1890 | 1875 | 1244 | 1535 | 1495 | 1455 |
| Density, | 2.985 | 4.54 | 6.11 | 7.14 | 7.43 | 7.874 | 8.90 | 8.908 |
| g/cm³ at | | | | | | | | |
| 20° C. | | | | | | | | |
| Kth, | 15.7 | 22.4 | 30.7 | 96.5 | 7.68 | 86.5 | 105 | 94.1 |
| W/m-K, | 15.8 | 21.9 | 30.7 | 93.9 | 7.83 | 80.4 | 100 | 90.9 |
| at 0° C., | — | 20.7 | 31.0 | 92 | — | 72.0 | 89 | 82.7 |
| 20° C., | | | | | | | | |
| 100° C. | | | | | | | | |
| Alpha | 31.7 | 21.2 | 16.3 | 14.1 | 13.9 | 13.2 | 12.0 | 12.0 |
| range, | | | | | | | | |
| microns | | | | | | | | |

TABLE 1B
Thermophysical Properties of Transition Metals of Period
5 in Groups 3 through 10 in the Periodic Table

| Group | 3 | 4 | 5 | 6 | 7 | 8 | 9 | 10 |
|---|---|---|---|---|---|---|---|---|
| Element | Y | Zr | Nb | Mo | Tc | Ru | Rh | Pd |
| MP, ° C. | 1530 | 1850 | 2468 | 2610 | 2200 | 2282 | 1960 | 1552 |
| Density, | 4.5 | 6.55 | 8.57 | 10.22 | 11.5 | 12.37 | 12.39 | 11.99 |
| g/cm³ at | | | | | | | | |
| 20° C. | | | | | | | | |
| Kth, | 17.0 | 23.2 | 53.3 | 130.0 | 50.9 | 117.0 | 151.0 | 71.68 |
| W/m-K, | 17.2 | 22.7 | 53.7 | 130.0 | 50.6 | 117.0 | 150.0 | 71.8 |
| at 0° C., | 17.7 | 21.8 | 54.8 | 135.0 | 50.1 | 115.0 | 147.0 | 73.0 |
| 20° C., | | | | | | | | |
| 100° C. | | | | | | | | |
| Alpha | 29.2 | 30.3 | 15.7 | 13.4 | 12.0 | 11.3 | 11.4 | 12.0 |
| range, | | | | | | | | |
| microns | | | | | | | | |

TABLE 1C
Thermophysical Properties of Transition Metals of Period
6 in Groups 3 through 10 in the Periodic Table

| Group | 3 | 4 | 5 | 6 | 7 | 8 | 9 | 10 |
|---|---|---|---|---|---|---|---|---|
| Element | La | Hf | Ta | W | Re | Os | Ir | Pt |
| MP, ° C. | 920 | 2227 | 2996 | 3410 | 3186 | 3045 | 2443 | 1769 |
| Density, | 6.17 | 13.30 | 16.65 | 19.30 | 21.0 | 22.59 | 22.56 | 21.45 |
| g/cm³ at | | | | | | | | |
| 20° C. | | | | | | | | |
| Kth, | 15.8 | 23.3 | 57.4 | 177.0 | 48.6 | 88.0 | 148.0 | 71.7 |
| W/m-K, | — | 23.0 | 57.5 | 173.0 | 48.0 | 87.6 | 145.0 | 71.6 |
| at 0° C., | — | 22.4 | 57.7 | 163.0 | 46.6 | 87.0 | 145.0 | 71.7 |
| 20° C., | | | | | | | | |
| 100° C. | | | | | | | | |
| Alpha | 26.6 | 14.3 | 11.3 | 9.8 | 9.1 | 8.5 | 8.6 | 9.1 |
| range, | | | | | | | | |
| microns | | | | | | | | |

The melting points and densities are taken from the Metals Handbook Desk Edition, Second Edition, J. R. Davis, Editor, p 629-633 (ASM).

Table 2 shows the thermal conductivities of the same elements provided in Table 1, but at higher temperatures of 1,000° C. (Table 2A), 1,300° C. (Table 2B), and 1,500° C. (Table 2C). The dashed entries (-) indicate no data measured, or that the temperature is above the melting point.

TABLE 2A
Melting Points and Thermal Conductivities (at 0° C., 20° C.,
100° C., 1,000° C., 1,300° C., 1,500° C.) of Transition Metals of
Period 4 in Groups 3 through 10 in the Periodic Table

| Group | 3 | 4 | 5 | 6 | 7 | 8 | 9 | 10 |
|---|---|---|---|---|---|---|---|---|
| Element | Sc | Ti | V | Cr | Mn | Fe | Co | Ni |
| MP, ° C. | 1539 | 1667 | 1890 | 1875 | 1244 | 1535 | 1495 | 1455 |
| Kth, | 15.7 | 22.4 | 30.7 | 96.5 | 7.68 | 86.5 | 105 | 94.1 |
| W/m-K, | 15.8 | 21.9 | 30.7 | 93.9 | 7.83 | 80.4 | 100 | 90.9 |
| at 0° C., | — | 20.7 | 31.0 | 92 | — | 72.0 | 89 | 82.7 |
| 20° C., | — | 22.5 | 41.7 | 61.9 | — | 72.0 | 89 | 82.7 |
| 100° C. | — | 25.1 | 45.5 | 56.1 | — | 32.7 | 42.8 | 84.0 (est) |
| 1000° C. | — | — | 48.1 | — | — | 34.3 | 43.1 | — |
| 1300° C. | | | | | | | | |
| 1500° C. | | | | | | | | |

TABLE 2B
Melting Points and Thermal Conductivities (at 0° C., 20° C.,
100° C., 1,000° C., 1,300° C., 1,500° C.) of Transition Metals of
Period 5 in Groups 3 through 10 in the Periodic Table

| Group | 3 | 4 | 5 | 6 | 7 | 8 | 9 | 10 |
|---|---|---|---|---|---|---|---|---|
| Element | Y | Zr | Nb | Mo | Tc | Ru | Rh | Pd |
| MP, ° C. | 1530 | 1850 | 2468 | 2610 | 2200 | 2282 | 1960 | 1552 |
| Kth, | 17.0 | 23.2 | 53.3 | 130.0 | 50.9 | 117.0 | 151.0 | 71.68 |
| W/m-K, | 17.2 | 22.7 | 53.7 | 130.0 | 50.6 | 117.0 | 150.0 | 71.8 |
| at 0° C., | 17.7 | 21.8 | 54.8 | 135.0 | 50.1 | 115.0 | 147.0 | 73.0 |
| 20° C., | — | 26.7 | 68.6 | 108.0 | — | 92.8 | 115.0 | 104.0 |
| 100° C. | — | 29.5 | 73.2 | 96.6 | — | 88.5 | 110.0 | 111.0 |
| 1000° C. | — | 31.2 | 76.1 | 93.3 | — | 86.2 | 110.0 | 115.0 |
| 1300° C. | | | | | | | | |
| 1500° C. | | | | | | | | |

TABLE 2C
Melting Points and Thermal Conductivities (at 0° C., 20° C.,
100° C., 1,000° C., 1,300° C., 1,500° C.) of Transition Metals of
Period 6 in Groups 3 through 10 in the Periodic Table

| Group | 3 | 4 | 5 | 6 | 7 | 8 | 9 | 10 |
|---|---|---|---|---|---|---|---|---|
| Element | La | Hf | Ta | W | Re | Os | Ir | Pt |
| MP, ° C. | 920 | 2227 | 2996 | 3410 | 3186 | 3045 | 2443 | 1769 |
| Kth, | 15.8 | 23.3 | 57.4 | 177.0 | 48.6 | 88.0 | 148.0 | 71.7 |
| W/m-K, | — | 23.0 | 57.5 | 173.0 | 48.0 | 87.6 | 145.0 | 71.6 |
| at 0° C., | — | 22.4 | 57.7 | 163.0 | 46.6 | 87.0 | 145.0 | 71.7 |
| 20° C., | — | 20.9 | 61.3 | 112.0 | 46.2 | 86.9 | 118.0 | 84.2 |
| 100° C. | — | 21.5 | 62.5 | 106.0 | 48.3 | 86.9 | 110.0 | 91.3 |
| 1000° C. | — | 22.0 | 63.3 | 103.0 | 49.8 | 86.9 | — | 95.7 |
| 1300° C. | | | | | | | | |
| 1500° | | | | | | | | |

Based on this data, we can make several observations to prioritize candidate coating materials. La and Tc can be excluded as previously mentioned, while Sc and Y are unlikely, but interesting light elements. Sc and Y have higher melting points than Mn, Co, and Ni, and are comparable to Fe and Pd. Zr and Hf (and Y) readily oxidize. Mn has both a low melting point and low thermal conductivity that is not suitable as a main alloy element but is a minor alloy element for stainless steels.

In terms of acceptance, the following observations were made:
Ranked by melting point: W, Re, Os, Ta, Mo, Nb, Ir
Ranked by kth: W, Rh, Ir, Mo, Ru
Ranked by least alpha range (or best stopping power): Os, Ir, Pt, Re, W, Ta, Ru, Rh, Pd
Ranked by elastic modulus (stiffness): Os, Ir, Re, Ru, W, Mo
Ranked by tensile strength: Os, Ir, W, Rh, Mo, Ru (note that W and Mo can be solid-solution strengthened with Re and dispersion strengthened with HfC, while Ir and Rh can be strengthened with Ru).
Overall best primary element: Ir (best for oxidation resistance, thermal conductivity, and alpha range).

Ir is compatible with Mo and may be alloyed with Mo or W for improved properties (Morris 1978).

Thermal conductivities and thermomechanical properties are discussed in the following sections. Optimal alloys are application-specific, and matching coating elements to specific use cases is an area for further research.

### 2.1.2 Thermal Conductivity

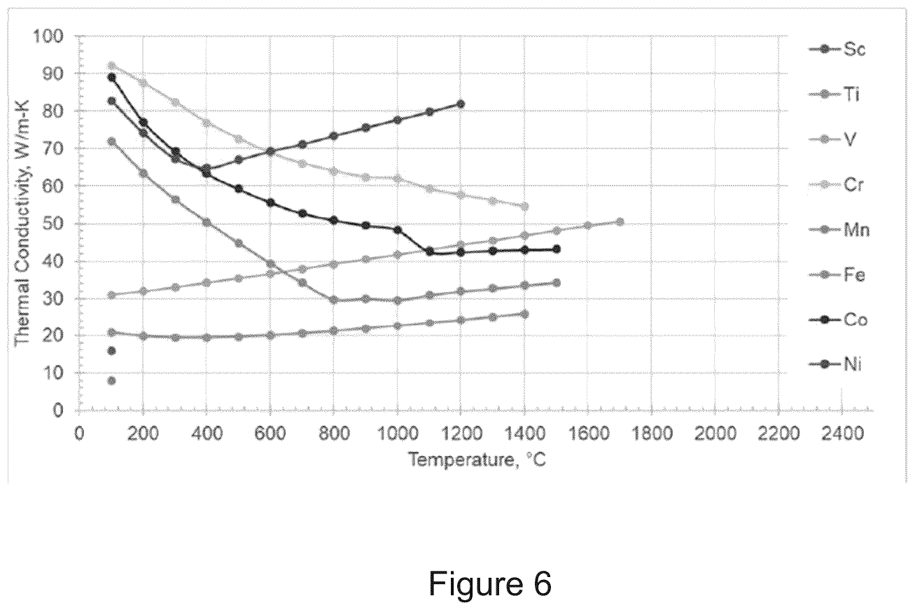

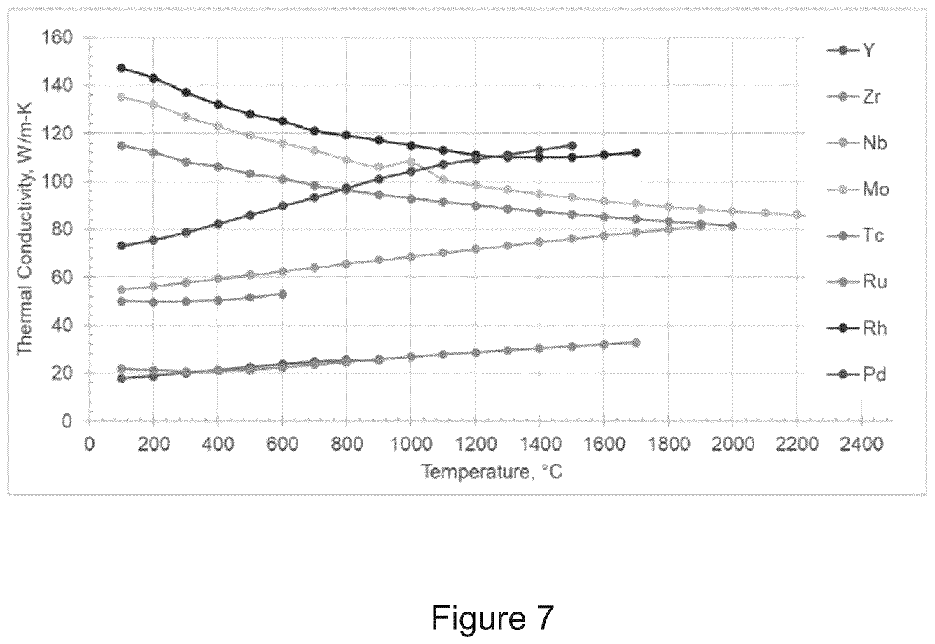

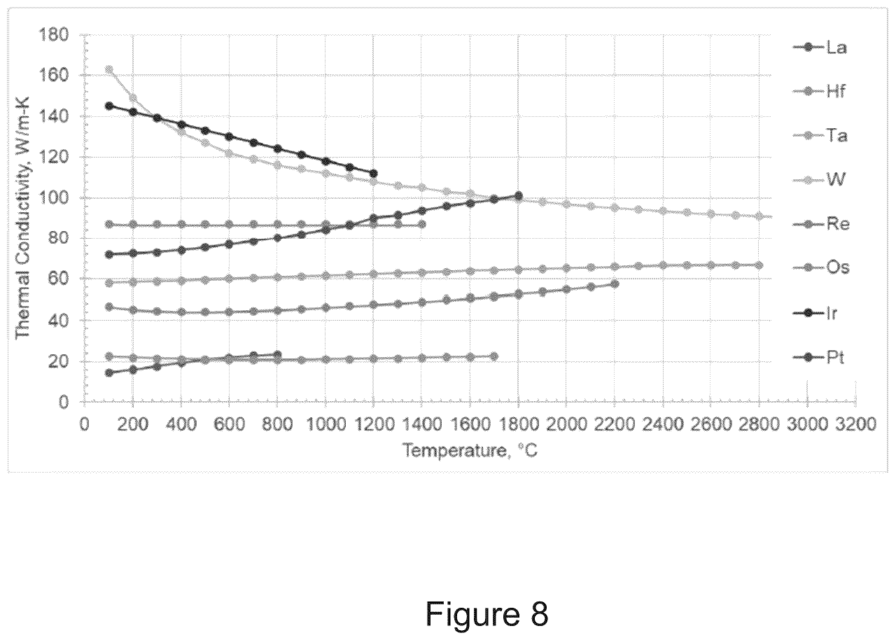

The thermal conductivities of the periods 4, 5, and 6 transition metals in Groups 3-10 of the periodic table are given in FIG. 6, FIG. 7, and FIG. 8, for Periods 4, 5, and 6, respectively. The data are taken from a comprehensive review of the thermal conductivity of the elements by Yo et al. (1974).

Sc and Mn have poor thermal conductivities, although not much information is available for Sc due to its rarity. The Group 4 elements (Ti, Zr, and Hf, all hexagonal close-packed metals) show very low thermal conductivity that increases slightly with temperature. The Group 5 elements (V, Nb, and Ta) have moderate thermal conductivities; the conductivities of V and Nb increase more strongly with temperature than that of Ta, although the conductivities of Nb and Ta are similar. Groups 6 and 8 elements show a decrease in thermal conductivity with temperature, although the conductivity of Os is relatively flat vs. temperature.

Group 7 metals have low thermal conductivity, with Mn having the poorest and Tc and Re having similar thermal conductivity. Group 9 metals (Co, Rh, and Ir) have relatively high thermal conductivity at room temperature but show decreasing conductivity with increasing temperature. Interestingly, Co shows lower conductivity than Cr, but for the corresponding heavier elements, the trend changes, with Rh having a greater conductivity than Mo, and Ir conductivity exceeding that of W over most of the temperature range for which there is data for Ir.

The Group 10 metal considered (Ni) shows a unique trend in which thermal conductivity decreases with temperature, but then turns around (at about 400° C.) and increases with temperature, while Pd and Pt show an increasing trend over their temperature ranges.

W has the highest thermal conductivity at room temperature but then falls below that of Rh and Ir, which have similar thermal conductivities, which appear to converge at 1,300° C. W has the highest melting point making it the only metal capable of performing at temperatures above Re and Os. For practical structural purposes, one would not use a structural material beyond about 0.8 homologous temperature, but at low stress, or more likely at lower values of 0.5 to 0.7, where creep would be a concern for service life. The homologous temperature of a crystalline material is defined as T/Tₘ, where T is temperature and Tₘ is the melting (solidus) temperature on an absolute scale, usually in Kelvin.

### Thermomechanical Properties

The room temperature mechanical properties are provided in Table 3 and Table 4 for the precious metal group elements and Period 5 and 6 reactive and refractory metals, respectively. The elastic moduli are compared in Table 5.

TABLE 3
Room Temperature Mechanical Properties of
Precious Metal Group Elements (Lyon 2010)

| | Elastic | | | |
|---|---|---|---|---|
| Element | Modulus, GPA | YS, MPa | UTS, MPa | Elongation, % |
| Ru | 420 | 370 | 430 | 3 |
| Rh | 315 | 80 | 700 | 15 |
| Pd | 115 | 50 | 190 | 40 |
| Os | 555 | Brittle | Brittle | Brittle |
| Ir | 515 | 235 | 1,100 (?) | 10 |
| Pt | 170 | 45 | 150 | 40 |
| Pt-40% Rh | — | 95 | 510 | 30 |

TABLE 4
Room Temperature Mechanical Properties of Refractory
and Reactive Elements (Unverified, for information
only) (Tietz and Wilson 1961)

| | Elastic | | | |
|---|---|---|---|---|
| Element | Modulus, GPA | YS, MPa | UTS, MPa | Elongation, % |
| Nb | 99, 103 | 207 | | 5-30 |
| Mo | 333 | 420 | 509 | — |
| Ta | 186 | 100 | 170-450 | 10-30 |
| W | 405-407 | 400, 750 | 980 | — |
| Re | 470 | 290 | 1070 | — |

TABLE 5
Room Temperature Elastic Moduli and Poisson's Ratio
of Period 5 and 6 Transition Metals (Darling 1966)

| | Crystal | E | G | K | | |
|---|---|---|---|---|---|---|
| Element | Structure | GPa | GPa | GPa | V | E/2G-1 |
| Zr | HCP | 94.7 | 35.7 | 88.6 | 0.33 | 0.325 |
| Nb | BFCC | 102.9 | 36.2 | 171.6 | 0.38 | 0.421 |
| Mo | BCC | 336.9 | 118.4 | 271.8 | 0.30 | 0.422 |
| Tc | HCP | 388.3 | 155.3 | 277.7 | 0.26 | 0.250 |
| Ru | HCP | 417.5 | 167.0 | 283.5 | 0.25 | 0.250 |
| Rh | FCC | 375.1 | 148.5 | 271.9 | 0.26 | 0.263 |
| Pd | FCC | 124.6 | 44.8 | 185.3 | 0.39 | 0.392 |
| Hf | HCP | 136.9 | 52.4 | 108.3 | 0.30 | 0.306 |
| Ta | BCC | 182.7 | 68.0 | 204.4 | 0.35 | 0.344 |
| W | BCC | 384.5 | 147.0 | 309.3 | 0.29 | 0.308 |
| Re | HCP | 458.2 | 174.8 | 330.1 | 0.26 | 0.311 |
| Os | HCP | 543.7 | 213.6 | 368.9 | 0.25 | 0.273 |
| Ir | FCCf | 522.6 | 207.8 | 367.0 | 0.26 | 0.258 |
| Pt | FCC | 168.9 | 60.4 | 272.7 | 0.39 | 0.399 |

The strongest/stiffest metal in Period 5 is Ru, with Os the strongest/stiffest in Period 6. These metals are consequently the most brittle. Iridium is the second strongest metal in Period 6, while Rh is the second, excluding Tc. The properties may vary considerably among similar elements or alloys from different sources. For example, Ru is reported to have an elastic modulus of 447 GPa, shear modulus of 173 GPa, bulk modulus of 220 GPa, UTS 370 MPa (materials-properties.org).

Strength can be increased for each element through solid solution strengthening, e.g., the addition of Re to Mo or W, or through dispersed strengthening (precipitation hardening) of carbides, e.g., HfC. Pt can be strengthened with additions of Rh and W, and Ir is strengthened with additions of W and small amounts (˜60 ppm) of Th and/or Ce (Axler and Eash 1987; Schneibel et al. 2017; Song et al. 2015) in Ir-alloy DOP-26.

Ir and Pt have the greatest oxidation resistance but lack strength at high temperatures, while W and Mo, and particularly their alloys, have high strength and creep resistance at very high temperatures, e.g., >1,300° C., but they lack oxidation resistance. An appropriate application may be to coat a ceramic oxide, e.g., PuO₂, with a layer of Ir or Pt (or alloy) and then apply a mechanical substrate consisting of an appropriate Mo or W alloy. This approach is discussed in the applications section.

### 2.1.4 Alpha Range of Metals

The range in air for a 5.6 MeV alpha particle from ²³⁸Pu is calculated to be 41.48 mm, based on an air density of 0.00129 kg/m³ and air molecular mass of 14.74 g/mol.

TABLE 6
Range of 5.6 MeV Alpha Particles in Periods 4, 5, and 6 Transition Metals

| | | | Element | | | | | Difference, | |
|---|---|---|---|---|---|---|---|---|---|
| | | Range in | At. | Element | Range | Range | NIST | Fraction | |
| Element | Z | air (mm) | Mass | Density | (mm) | (microns) | CSDA | (Tsoulf − NIST) | |
| Sc | 21 | 41.47882 | 45.956 | 2.98 | 0.0317 | 31.65 | | | |
| Ti | 22 | 41.47882 | 47.867 | 4.54 | 0.0212 | 21.24 | 18.07 | 3.17 | 0.175 |
| V | 23 | 41.47882 | 50.942 | 6.11 | 0.0163 | 16.28 | | | |
| Cr | 24 | 41.47882 | 51.996 | 7.14 | 0.0141 | 14.08 | | | |
| Mn | 25 | 41.47882 | 54.938 | 7.43 | 0.0139 | 13.90 | | | |
| Fe | 26 | 41.47882 | 55.845 | 7.87 | 0.0132 | 13.23 | 11.54 | 1.69 | 0.147 |
| Co | 27 | 41.47882 | 58.933 | 8.90 | 0.0120 | 12.02 | | | |
| Ni | 28 | 41.47882 | 58.693 | 8.91 | 0.0120 | 11.99 | | | |
| Y | 39 | 41.47882 | 88.906 | 4.50 | 0.0292 | 29.20 | | | |
| Zr | 40 | 41.47882 | 91.224 | 6.55 | 0.0203 | 20.32 | | | |
| Nb | 41 | 41.47882 | 92.906 | 8.57 | 0.0157 | 15.68 | | | |
| Mo | 42 | 41.47882 | 95.95 | 10.22 | 0.0134 | 13.36 | 11.47 | 1.89 | 0.164 |
| Tc | 43 | 41.47882 | 98 | 11.50 | 0.0120 | 12.00 | | | |
| Ru | 44 | 41.47882 | 101.97 | 12.37 | 0.0113 | 11.33 | | | |
| Rh | 45 | 41.47882 | 102.906 | 12.39 | 0.0114 | 11.41 | | | |
| Pd | 46 | 41.47882 | 106.42 | 11.99 | 0.0120 | 11.99 | | | |
| La | 57 | 41.47882 | 138.905 | 6.17 | 0.0266 | 26.62 | | | |
| Hf | 72 | 41.47882 | 178.49 | 13.00 | 0.0143 | 14.32 | | | |
| Ta | 73 | 41.47882 | 180.948 | 16.65 | 0.0113 | 11.26 | | | |
| W | 74 | 41.47882 | 183.94 | 19.30 | 0.0098 | 9.79 | 10.17 | −0.37 | −0.037 |
| Re | 75 | 41.47882 | 186.207 | 21.00 | 0.0091 | 9.06 | | | |
| Os | 76 | 41.47882 | 190.23 | 22.59 | 0.0085 | 8.51 | | | |
| Ir | 77 | 41.47882 | 192.217 | 22.56 | 0.0086 | 8.56 | | | |
| Pt | 78 | 41.47882 | 195.084 | 21.45 | 0.0091 | 9.08 | 9.52 | −0.44 | −0.047 |

The ranges of alpha particles in Periods 4 and 5 seem to be conservatively estimated compared to current National Institute for Standards and Technology (NIST) data; however, the ranges may not be conservatively estimated for Period 6 elements. In all three periods, the alpha range decreases with increasing Z, which is consistent with the dominance of the electron-stopping power.

The range of an alpha particle in the air is given by the equation (Tsoulfanidis and Landsberger 1995):

$${R}_{a i r} ( mm ) = ( 0.05 T + 2.85 ) {T}^{3 / 2} ( Me V ) , 4 \leq ; T < 15 Me V ,$$

where T is the kinetic energy of the alpha particle.

The range of alpha particles Rₘ in a different material based on the Bragg-Kleeman rule (Tsoulfanidis and Landsberger 1995) is as follows:

$$\frac{{R}_{2}}{{R}_{1}} = \frac{{ρ}_{1}}{{ρ}_{2}} \sqrt{\frac{{A}_{2}}{{A}_{1}}} , let {R}_{2} = {R}_{m} = and {R}_{1} = {R}_{a i r} ⇒ {R}_{m} = {R}_{a i r} \frac{{ρ}_{a i r}}{{ρ}_{m}} \sqrt{\frac{{A}_{m}}{{A}_{a i r}}} .$$

NIST data on continuous slowing down approximation (CSDA) may be found online at NIST's website://physics.nist.gov/cgi-bin/Star/ap_table.pl.

In terms of stopping power for alpha particles, the following elements are ranked from most effective (greatest stopping power or shortest range) to least effective: Os, Ir, Pt, Re, W, Ta, Ru, Rh, Pd(Ni). The most oxidation-resistant elements, Ir and Pt, are also the most effective for stopping alpha particles after Os, which has poorer oxidation resistance.

### Cost of Precious Metal Group and Reactive/Refractory Metals

Precious metal group elements are typically used in very thin (microns) layers due to their high cost. Reactive and refractory metals are less expensive, but they are used for special applications requiring high temperatures. The prices of reactive/refractory and precious metal group elements are subject to considerable market volatility due to the availability (often from sensitive nations and rarity) and demand volatility. As of August 2024, the price of Rh, which was the highest of the precious metal group, fell below that of Ir.

Some representative prices (for information only, as of August 2024) are as follows:
Osmium:
$41,351.00 per troy oz ($1,329,464/kg)
>$64,000.00 per troy oz (>$2,057,645/kg)
Rhodium:
˜$4700 per troy oz ($151,092/kg)
Iridium:
˜$4700 per troy oz ($151,092/kg)
Palladium:
˜$947.00 per troy oz ($30,443/kg)
Gold:
$1,774.70 per troy oz. ($57,057/kg)
Platinum:
˜$948.00 per troy oz ($30,475/kg)
Ruthenium:
˜$400.00 per troy oz. ($12,859/kg)
Tungsten:
˜$45,000 to 50,000 per metric ton (˜$45-50/kg)
Cobalt:
$33,000 per metric ton ($33/kg)
Molybdenum:
$26,000 per metric ton ($26/kg)
Nickel:
$22,134.78 per metric ton ($22/kg)
Copper:
$8,243.16 per metric ton ($8/kg)
Iron:
$104.52 per metric ton ($0.10/kg)

Osmium is the most expensive, followed by Rh and Ir. Rhodium is much more expensive than iridium, but prices of Rh fell considerably from 2021 through 2023, and now Rh is less expensive than Ir, although the price of both seems to be converging. Prices are subject to change (during some periods the change can be dramatic depending on supply and demand) and are provided for general information only.

### Applications of Precious Metal-Coated Microspheres

RPS are a mature technology in the United States. Alloys of Ir and Pt have been developed for this application, using fuels such as ²³⁸PuO₂. Encapsulating microspheres of PuO₂ requires at least 10 microns, and preferably 15 microns, of Ir or Pt to stop all alpha particles from escaping the ceramic microsphere. If additional thickness is needed, Mo-alloy may be overlaid on the Ir base.

For nuclear reactor systems, a Mo—Re-alloy may be best suited in terms of strength at high temperatures, high thermal conductivity, relatively low density compared to heavier metals (Ta, W, Re, and Ir), and low cost, compared to the precious metal group elements. Luo et al. (1994) provided a review of the status of Mo 5 wt % Re 0.5 wt % HfC as of 1994, which is a type of Mo-RHC, which was still in the research stage at the time, and currently, there is no UNS number of ASME code or ASTM standard for the alloy or its derivatives. Obtaining an ASME code case and UNS number requires the production of several heats of the material, usually at least three heats in commercial quantities fabricated in the appropriate form. While there are several Mo alloys manufactured in commercial quantities, Mo-RHC is so unique (can be costly) that it is not a commercial grade. Yet, of the potential alloys for a high-temperature nuclear reactor, it would be advantageous to use a Mo-alloy over W and Ta alloys (Klopp 1985) due to its lower neutron absorption (capture) compared to W or Ta. Some of the precious metal groups, namely Ru, Rh, Ir, and Pt, may provide a benefit to a Mo—Re—HfC-alloy system, e.g., as a protective surface coating or alloying agent, but this must be explored, and little has been done since 1994, or even since 1984.

For both applications in RPS or high-temperature nuclear reactors, the issue of compatibility or stability of layered precious metal groups and reactive/refractory alloys must be considered. In some cases, e.g., Ir, the compatibility of metal oxides has been assessed (Axler and Eash 1987). Furthermore, the compatibility of Ir and Mo has been addressed by J F Morris in U.S. Pat. No. 4,111,718 (Morris 1978).

In the summary of that invention, the inventor notes, “Sensors composed of molybdenum, iridium, and alloys containing only these two metals provide advantages over prior art thermocouples as a result of the physical and chemical compatibility of molybdenum and iridium at high temperatures and in vacuum systems.” Furthermore, the inventor states, “The compatibility of molybdenum and iridium at elevated temperatures reduces the problem of preferential evaporation in the molybdenum, iridium thermocouple sensor to provide a more stable emf-temperature relationship. The vapor pressure and physical and chemical compatibility of molybdenum, iridium, and alloys containing only these two metals reduce thermocouple hot-junction failures and allow such sensors to be employed in high-temperature and vacuum systems without the necessity of metallic sheaths and ceramic insulation at operating temperatures up to about 2,450° C. The advantages of the present invention are further enhanced over tungsten-rhenium and tantalum-rhenium combinations in that the present invention does not contain rhenium which is often very expensive and sometimes unavailable.” Since the patent was awarded, rhenium is more readily available, and its relative cost has been reduced. It should be noted that Ir would have no strength at ˜2,450° C., and Mo would have little strength. Such a high temperature would require a W alloy, carbide, and perhaps graphite structure, or some combination. Further research is needed to identify the appropriate alloy for the desired temperature and coolant environment.

Coating compatible with other fuel materials, e.g., UMo, UZr, UC, or UN, must be further researched; UN is preferred for the higher thermal conductivity and low fission gas release; however, at very high temperature and with irradiation, free nitrogen becomes available and would chemically interact with the cladding. Rhenium (Re) has been proposed as a coating, but a precious metal group may also be applied, possibly to the ceramic fuel particles. The coating (Ir, Pt, and Rh) should be as thin as possible, and also be compatible with the cladding material,
which would likely be a Mo—Re alloy for minimal parasitic neutron absorption (Klopp 1985).

Garcia and Goto (2003) suggest Ir is compatible with graphite, and possibly carbides: “[chemical vapor deposition (CVD)] of iridium is of interest to prepare oxidation-resistant protective coatings on structural graphite for temperatures above 1773K because of the compatibility of iridium with carbon materials (i.e., no carbide formation).”

For catalysis, and particularly selective catalysis, it may be desirable to have different layers, perhaps porous layers, of precious metal group elements on the surface of an oxide microsphere. The microsphere could be alumina (Al₂O₃), yttria (Y₂O₃), ceria (CeO₂), zirconia (ZrO₂), or some other rare earth oxide.

Vargas Garcia and Goto also point to interests in depositing platinum, rhodium, and palladium on surfaces for catalytic function, e.g., “Platinum catalysts prepared in a fluidized-bed CVD reactor are promising for hydrocarbon conversion applications.”

More pointed, Shapley et al. (2002) show an interest in “bimetallic clusters of Ir and Mo deposited on ‘fumed alumina’.”

### Experimental Methods

The following were purchased from Milipore Sigma and used without further purification:
Platinum acetylacetonate (Pt acac, CAS: 15170-57-7, 99.8%)
Platinum (II) chloride (PtCl₂, CAS: 10025-65-7, 98%)
Palladium (II) chloride (PdCl₂, CAS: 7647-10-1, 99%)
Iridium (III) chloride (IrCl₃, CAS: 10025-83-9, 99.8%)
Tungsten hexacarbonyl (W(CO)₆, CAS: 14040-11-0, 97%)
Rhenium (III) chloride (ReCl₃, CAS: 13569-63-6, 99%+)
Rhodium acetylacetonate (Rh acac, CAS: 14284-92-5, 97%)
Ruthenium (III) chloride (RuCl₃, CAS: 14898-67-0, 99.9%+)
Tantalum (V) chloride (TaCl₅, CAS: 7721-01-9, 99.8%+)
Molybdenum (V) chloride (MoCl₄, CAS: 10241-05-1, 95%)
Titanium (IV) chloride (TiCl₄, CAS: 7550-45-0/99%+)
Ethylene glycol (EG, CAS: 107-21-1, 99%+)
Choline chloride (CAS: 67-48-1, 99%+)
(3-aminopropyl) trimethoxysilane (APTMS, CAS: 13822-56-5, 97%)
Potassium hydroxide (KOH, CAS: 1310-58-3, 99%+)
Methanol (MeOH, CAS: 1310-58-3, 99%+).

### Metallic Coating Methods

The coating is applied in three steps:
1) A surface preparation step resulting in N—CeO₂
2) A functionalization step resulting in CeO₂—NH₂
3) An electroless plating step resulting in CeO₂ microspheres coated with metal.

For the first step, a sample of the ceria microspheres, typically 50-150 mg, was added to a 20 mL glass vial with a small, glass-coated stir bar that had previously been acid-leached. One mL of ammonium hydroxide (14.8 M) and 5 mL deionized water were added to the vial. The vial was then capped, and the solution was stirred at 100 rpm at room temperature for 24 hours. The solution was decanted off the microspheres and added to a waste container. A squeeze bottle was used to rinse the entire inner surface of the vial with DI water, using approximately 5 mL of water. The microspheres were manually swirled in the water in the vial for approximately 30 seconds, then the rinse water was decanted, and also added to the waste container. This process was repeated twice, for a total of three rinses. At any point, if any of the microspheres were floating on the surface of the liquid, the vial was capped and centrifuged at 4,400 rpm for 2 minutes before decanting. The vial was held at an angle and tapped on a firm surface (e.g., the bottom of a fume hood) to spread the microspheres across the bottom of the vial, then the entire vial was placed into a forced air convection oven at 105° C. The microspheres were dried until they flowed freely across the bottom of the vial, typically 30-60 minutes. The microspheres were stored in the vial, capped, until use.

For the second step, a sample of the N—CeO₂ microspheres, typically 5-80 mg, was added to a 20 mL glass LSC vial with a small, glass-coated stir bar that had previously been acid-leached. Ten mL of methanol and 0.5 uL of (3-aminopropyl) trimethoxysilane (APTMS) were added to the vial. The vial was then capped, and the solution was stirred at 400 rpm at room temperature for 30 minutes. The solution was decanted off the microspheres and added to a waste container. The vial was held at an angle and tapped on a firm surface (e.g., the bottom of a fume hood) to spread the microspheres across the bottom of the vial, then left uncapped and allowed to air dry until the microspheres flowed freely across the bottom of the vial, typically 30-60 minutes. The microspheres were then either used immediately or stored in the vial, capped, until use.

For the third step, one bead of KOH (typically 0.1 g) was added to 20 mL of ethylene glycol in a 20 mL glass LSC vial and sonicated until dissolved, typically 20-30 minutes. The prepared solution was stored in a laboratory refrigerator until used. A sample of the CeO₂—NH₂ microspheres, typically 2-20 mg, was added to a 20 mL LSC vial with a small, glass-coated stir bar that had previously been acid-leached. Twenty-five uL of 1-butyl-3-methylimidazolium tetrafluoroborate (BMIM-BF₄) and a metal precursor, typically 3-10 mg, were added to the vial with 10 mL of the KOH/ethylene glycol mixture. A list of the metal precursors used can be found in Table 7. The vial was then capped, and the solution was stirred at 400 rpm on a hot plate set to 195° C. for some time, typically 6 hours. The heating function on the hot plate was turned off, but the stirring was left on while the vial cooled. Once the vial was cool enough to handle, typically 30 minutes, the vial was centrifuged at 4,400 rpm for 2 minutes. The solution was decanted off the microspheres and added to a waste container.

TABLE 7
Metal Precursors and Summary Results of the Coating Process

| Metal Precursor | Alloys Attempted |
|---|---|
| Platinum acetylacetonate (Pt Acac) | |
| Platinum (II) chloride (PtCl₂) | Pt/Rh |
| Palladium (II) chloride (PdCl₂) | |
| Iridium (III) chloride (IrCl₃) | Ir/W |
| Tungsten hexacarbonyl (W(CO)₆) | Ir/W, Re/W |
| Rhenium (III) chloride (ReCl₃) | Re/W |
| Rhodium acetylacetonate (Rh Acac) | Pt/Rh |
| Ruthenium (III) chloride (RuCl₃) | |
| Tantalum (V) chloride (TaCl₅) | |
| Molybdenum (IV) chloride (MoCl₄) | Mo/Re |
| Titanium (IV) chloride (TiCl₄) (in Ethaline solvent) | |

Two other types of coating were attempted: alloy coatings (two metals applied simultaneously) and double coatings (two metals applied sequentially). For alloy coatings, two metal salts were added to the vial. A list of the alloys attempted can be found in Table 7. For double coatings, the microspheres were heat treated at 250° C. for 72 hours in a vacuum furnace (rough pump). Then, the electroless plating step was repeated with a second metal. The double coatings attempted were platinum over iridium and palladium over iridium.

### Cerium Leach Testing

As iridium coating was selected based on positive coating results and the guidance of the materials selection team, both iridium-coated and coated microspheres were heated in a furnace and then exposed to methanol (dissolves CeO₂) for 72 hours. In such a way any holes in the iridium coating would correspond to increased cerium concentration when the leachate was processed by an external inductively coupled mass spectrometry (ICPMS) team.

Both pre-coated cerium microspheres and powders that had been previously heated to 1,600° C. were used to benchmark the test. Iridium-coated spheres were first heated to 400° C. in air for 1 hour to drive off any water and organics then heated to 1,000° C. for 2 hours in air. The furnace schedule was thus:
1) Ramp up 20° C.-400° C. at 10° C./min (38 minutes)
2) Hold at 400° C. for 60 minutes
3) Ramp up 400° C.-1,000° C. at 2° C./min (300 minutes)
4) Hold at 1,000° C. for 120 minutes
5) Let cool to ambient (about 6 hours).

Samples of the spheres at each process step were then exposed to pure methanol at ambient for 72 hours. The liquids were collected and analyzed for cerium concentration (as well as other contaminants such as iridium). This methodology allowed for the quantitative determination of the leach rate of the spheres and for an objective lens through which to evaluate the protective properties of the metal coating.

### Characterization Equipment

Optical imaging was taken with an OMAX 2400 UV-epi fluoroscope (100 W mid-pressure UV bulb centered at 325 nm, broad emission) and Dinolite 375 nm emitting endoscope (AM4517MT-FUW). All sample stages were mounted with vendor-supplied 4-axis. The images were recorded with vendor-supplied software and converted to bit maps for processing, if available, and the scale bars were burned into the images for direct control of the scale during processing. The images were processed with Image J software v.1.54f.

Scanning electron microscopy (SEM) was performed on a JEOL IT-800 equipped with an Oxford X-Max energy dispersive spectrometer (EDS). Variable accelerating voltages ranging from 5 to 30 kV were used. Scanning transmission electron microscopy (STEM) was done on a JEOL ARM200CF aberration (Cs) corrected microscope operated at 200 kV using a JEOL Centurio EDS detector with a solid collection angle of 0.9 sR.

XPS measurements were performed using a Physical Electronics Quantera SXM Scanning X-ray Microprobe. This system uses a focused monochromatic Al Kα X-ray (1486.7 eV) source for excitation and a spherical section analyzer. The instrument has a 32-element multichannel detection system. The X-ray beam is incident normal to the sample and the photoelectron detector is at 45° off normal. High-energy resolution spectra were collected using a pass-energy of 69.0 eV with a step size of 0.125 eV. For the Ag 3d_{5/2} line, these conditions produced a full width at half max (FWHM) of 0.92 eV±0.05 eV. The binding energy (BE) scale is calibrated using the Cu 2p_{3/2} feature at 932.62±0.05 eV and Au 4f_{7/2} at 83.96±0.05 eV. Low energy electrons at ˜1 eV, 20 μA, and low energy Ar⁺ ions were used to minimize sample charging during analysis.

### Methodology of Size Determination

Images were analyzed to determine the diameter of the spheres. First, the size of a pixel in the image needed to be equated to a length. An image taken with the same machine will produce the same scale each time. The length of a pixel may vary based on the magnification factor.

This is all handled by setting the scale in ImageJ to each image containing samples. By telling ImageJ some number of k pixels are 1 μm, we know there are k pixels per 1 μm, so a sample with a diameter of d pixels is d*k/1 μm. Each sample in a photo was measured to a minimum of 20 samples. However, the photos of uncoated cerium oxide before any attempt at electroplating had a minimum of 30. This was an attempt to reduce the magnitude of the margin of error for the “true” diameter.

All data collected with ImageJ was analyzed using Microsoft Excel. The primary derived metrics were the mean diameter, and a 95% confidence interval of the population mean. Data was also analyzed for outliers. If an outlier was found, the analysis to find the mean and 95% confidence interval was conducted with and without the outlier. Outliers were defined as being 1.5 times larger than the third quartile or 1.5 times smaller than the first quartile.

Measuring diameter with photos and ImageJ presents some sources of discrepancies and limitations. Identifying pixels that contain samples is up to the researcher and is limited by image quality. This is mitigated by consistency; the same researcher should measure all the samples for a given experiment. Although not ideal, this will help maintain systemic errors. Another example is the focus and megapixel count of the camera taking the photos to be analyzed. Due to the scale of the samples and the monocular camera lens, not all samples may have the same focus, and some samples may appear ellipsoidal although those samples are spherical. A higher megapixel count allows for more image fidelity.

### Results

Three types of cerium oxide spheres were studied in this work. There were two cerium oxides fired to 650° C. and washed by different methods (Katalenich 2017) and one fired to 1600° C. The ceria spheres' surfaces are compared in FIG. 6. FIG. 6a shows the XPS data for the higher-fired ceria with an inlay micrograph of the white spheres. The spheres seen in FIG. 6b were fired at a lower temperature and appear to contain less salt contamination on the surface compared to FIG. 6a. The spheres were then coated with an amine layer to continue the coating process.

The XPS response of the amine-terminated spheres shows the addition of nitrogen response to the CeO₂ signature, FIG. 7c. It was found that the amine termination procedure would dissolve the ceria microspheres after 16-24 hours. As a result of this, the amine termination procedure was shortened to 4 hours, which had no discernible influence on the diameter of the ceria microspheres.

Amine-terminated spheres were then coated in various metals. The XPS spectrum from an iridium-coated sphere is seen in FIG. 7d. The presence of iridium is seen in the spectrum along with a decreased presence of carbon and oxygen, suggesting the metallic composition of the coating. The coatings were then analyzed for composition with electron microscopy.

FIG. 8, presents the SEM/EDS analysis of the coated spheres. FIG. 8a shows a micrograph of the ceria sphere with the pores to the interior of the sphere visible on the surface. FIG. 8b shows a ceria sphere after coating with iridium. The diameter has increased, and charge trapping (white signal hue) is seen on the metallic shell as the core-shell nature of these structures lends itself to a natural capacitor. The EDS data presented in FIG. 8c shows the cerium signal map confirming that the ceria is still inside the metal shell. The metal signal map also shows that the metal is outside the core by the increase as the edge of the sphere is scanned, FIG. 8d. As the coatings appear to be mostly metallic, optical imaging and analysis were used to determine the shell thicknesses.

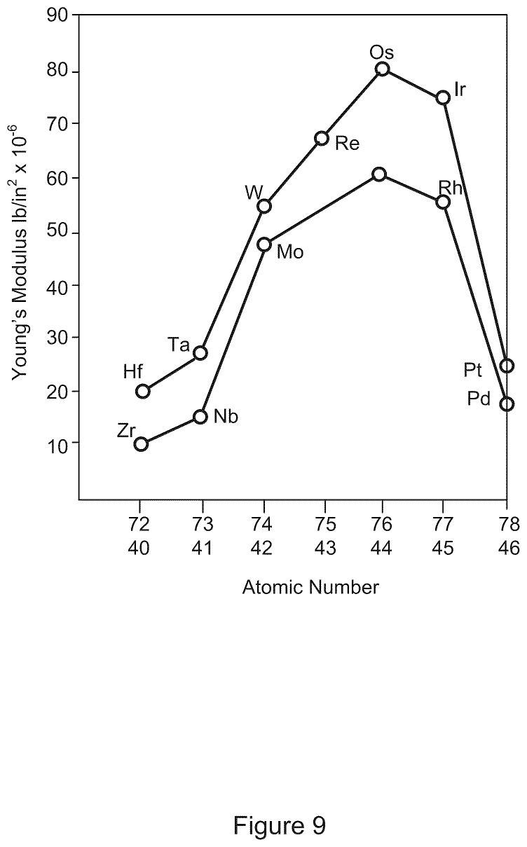

A direct size comparison is presented in the image shown in FIG. 9a. The darker metal-coated spheres are significantly larger than the cerium cores (light yellow-green spheres). After coating, large batches such as the one shown in FIG. 8b could be used to gain a statistical understanding of the sphere diameters and thus shell thickness. Optical imaging also verified that the spheres were completely covered by looking for light transmission through the metal coatings (FIGS. 8c and d). Ultraviolet imaging was used as well to evaluate that metal reduction was complete by evaluating the spheres for surface salt and aromatic carbon content, FIG. 8e. Last, a final check was completed with red to near-infrared imaging of the spheres to evaluate the presence of oxide formation in the coatings, as oxides tend to fluoresce and reflect these wavelengths. The metal sphere data was then compiled for comparison between metals and alloys.

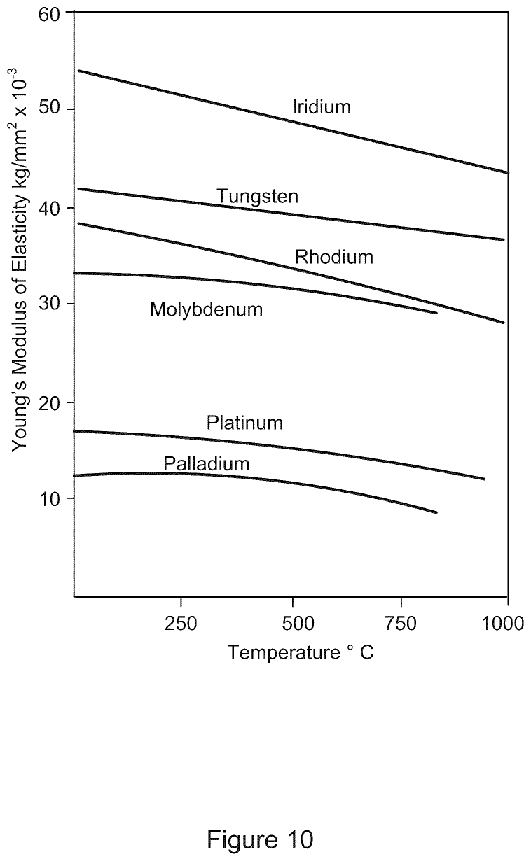

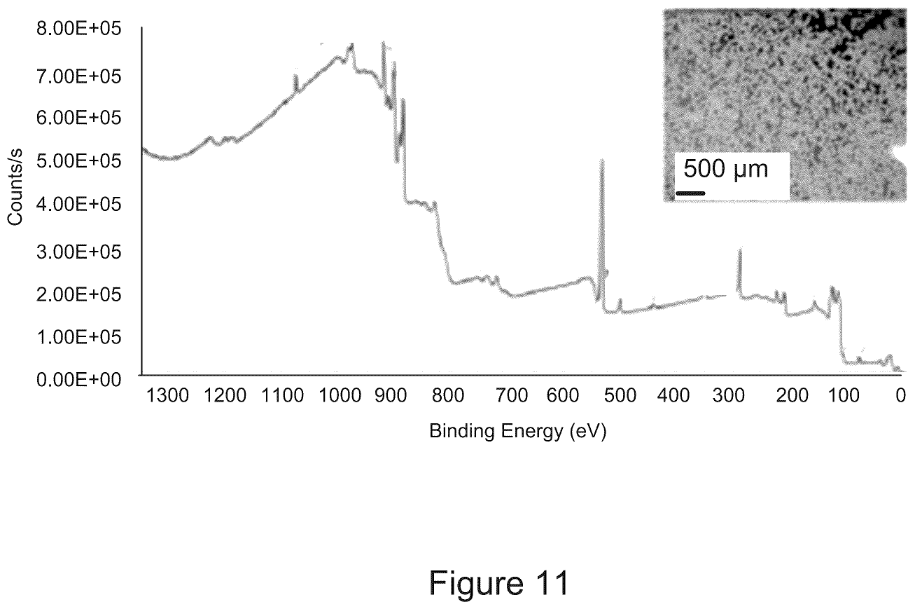

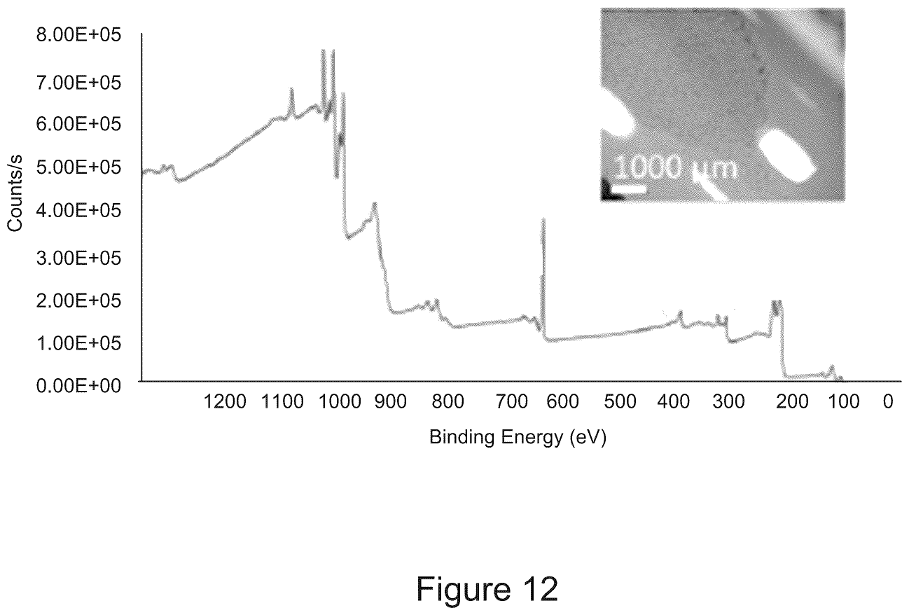

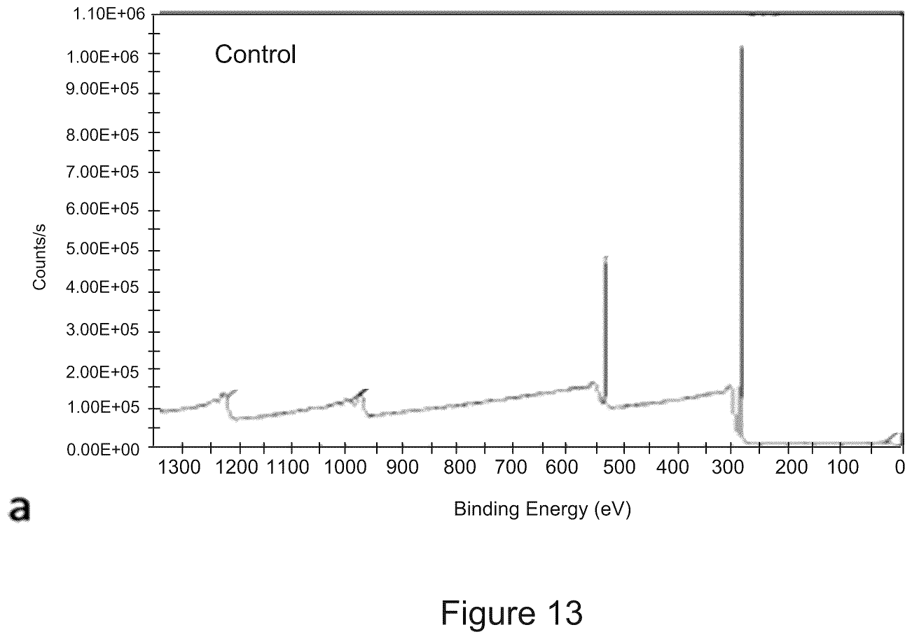

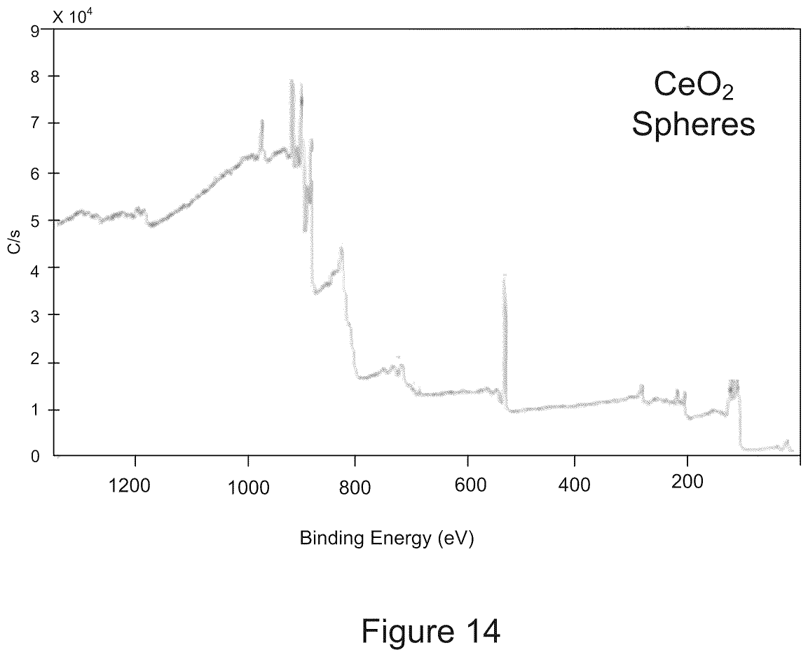

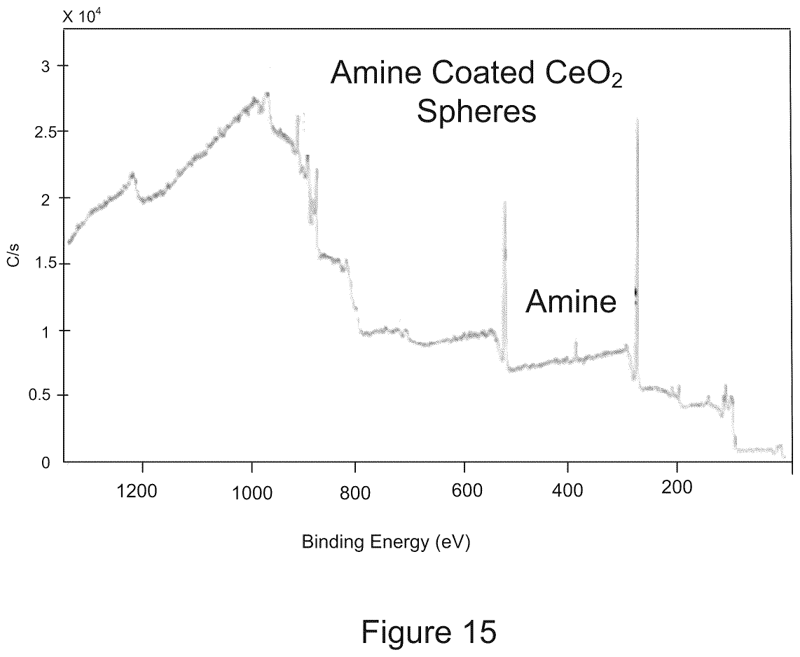

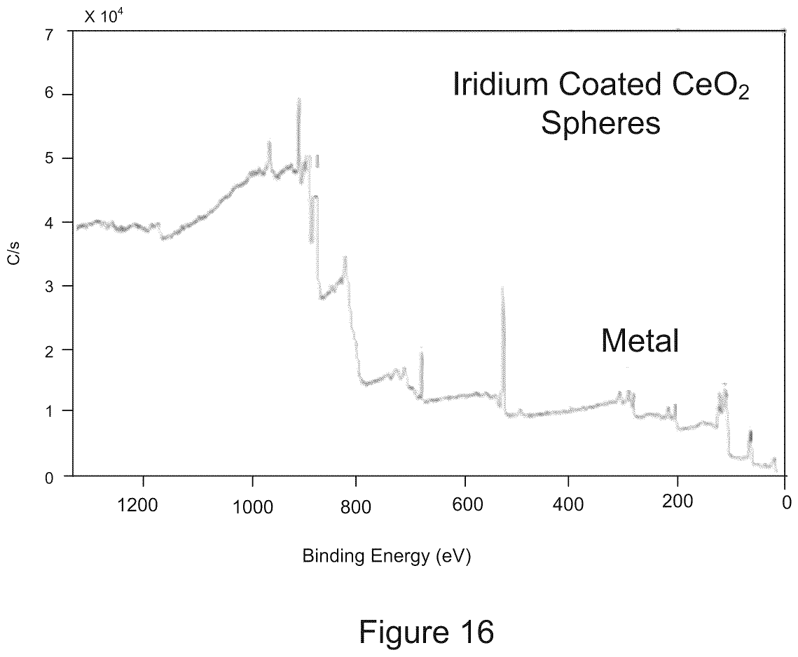

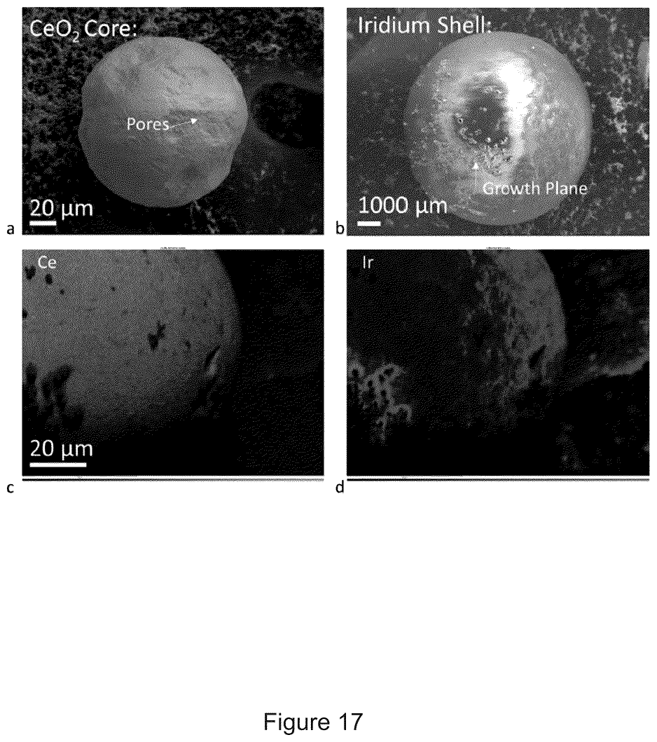

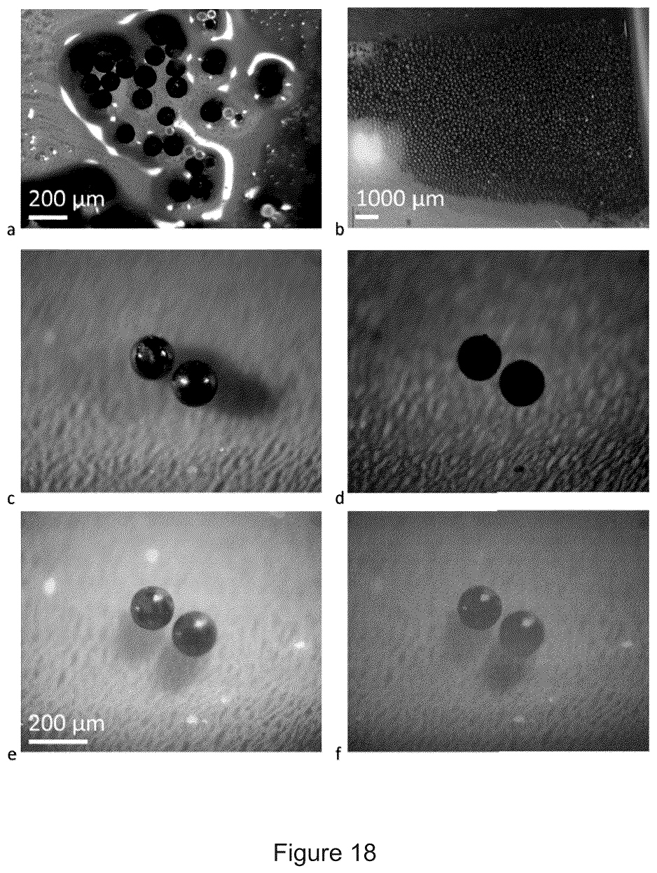

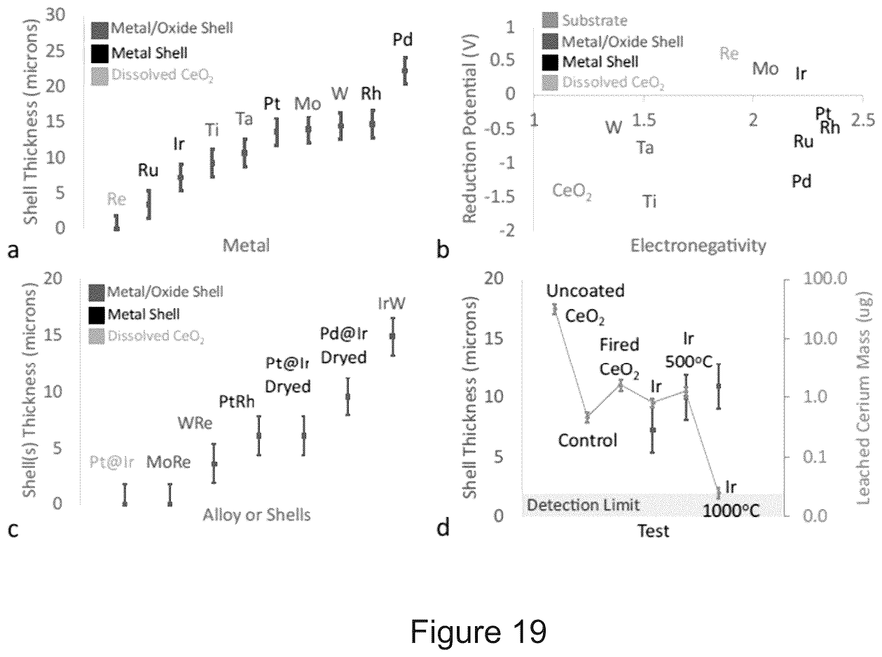

The calculated shell thickness for each pure metal coating is plotted in FIG. 10a. The success of each coating is demarked by a blue title for mixtures of metal and oxide, a black mark for metal coating, and gray if the coating failed and/or destroyed the ceria cores. The atoms of metal added to the sphere compared to the atoms of cerium in the core range from 0.72 to 2.50 with the coatings approaching a 1:1 ratio (˜a 15-micron thick shell) until palladium, which is the only metal to exceed a ratio of one. The reduction potential vs. the electronegativity of the metal shows 3 general groups in relation to the core ceria, as shown in FIG. 10b.

With pure metal coatings aligned into groups by successful metal coating, alloys were then tried, and the results are plotted in FIG. 10c. Along with alloys (a 1:1 mole ratio was attempted in this work), some subsequent double metal coatings were attempted. Finally, as iridium coating was seen as the most applicable to an accident-tolerant fuel, coated spheres were leach tested before and after firing. The results are presented in FIG. 10d.

### Discussion

The process overall was a success in coating ceria oxide microspheres with metal. Generally, the process produces metal films in line with general metal polyol reduction (Hubbard 2016).

The final shell thickness equates to 0.7-1 ratio to the mol ratio in all but one case (palladium, data shown in FIG. 10a). This reasonably corresponds to the amine: Ce ratio in FIG. 7c (0.8-1). Thus, the functionalization with amines saturates the pores of the cerium oxide cores and is used to maximize the metal deposition during the electroless coating process. The metal-to-surface site ratio aligns well with the previously established work in this area (Hubbard 2016). As an approximate check, the amount of metal added to the spheres makes physical
sense and appears to correspond to a mechanism where the amine functionalization has coated nearly all the surface area of the pore network within the ceria. This is further corroborated by the fact that the ceria spheres fired to a temperature where their pore networks had closed only contained spotty to no metal coating. Thus, a substrate oxide with a substantial pore network amiable to functionalization is a necessity for the plating mechanism.

The nature of the compositions as analyzed in FIG. 7d, FIGS. 8c and d, and FIG. 9c-f suggest that in several cases, the spheres are coated in metal. Evaluation of the metallic properties (such as electronegativity) and the coating reactions reduction potential lead to three distinct groups (shown in FIG. 10b):
1) Those coating near the electronegativity of cerium produced only mixtures of metal and oxide (termed “black metal” colloquially)
2) The coatings with an electronegativity of greater than 2.15 (Pauling basis) produced reliable metal coatings
3) Coatings with positive reduction potentials are more complicated to evaluate and require further research.

The metal coatings have a path to explain their coating performance, and the results appear to align with a mechanism needing a pore network in the ceria to provide sufficient electrostatic charge when coating.

Alloy coatings attempted in this work have several conclusions. Generally, alloy coatings were thinner than either of their constituent metals. In all but one case, the presence of a metal/metal oxide coating reaction led to an almost entirely oxide shell (with some cases being optically transmissive). As alloy coating is possible but complicated, double coating was investigated.

The double coating is possible with one key process addition: the necessity to consolidate in a vacuum furnace the primary metal coating before continuing with a second metal coat.

Investigations into coating one metal and then directly coating a second ended in the dissolution of the shells and cores entirely. When the first coating had been heated to drive off the solvent at 250° C. in a vacuum for 72 hours, the second layer was plated. It should be noted that the second coating is typically only a micron or so thick, as it is difficult to access the amine termination through the primary metal coat. Thus, double layers are possible, but their added complications led to the selection of an iridium metal coat for leach testing.

As the hypothesis of this work was that a ˜10 μm thick coating could withstand dissolution of the cerium for 72 hours, iridium was evaluated. The controls all leached around 1 microgram of cerium from a standardized mass of spheres (by cerium content). Initially, iridium coating appeared to have half that mass loss, with lower (400° C.) firing doing little to influence the rate of dissolution (FIG. 10d). Upon firing to 1,000° C., the mass loss of the core was reduced to the detection limit of the ICPMS system. Thus, it has been determined that the metal coatings can, in the case of iridium, provide leach protection to the cerium cores. This evaluation of the leaching data supports the hypothesis of this work.

### Continuation of Lessons Learned & Further Development

What follows are other key takeaways that will influence the success of further development of this coating technique:
Chloride salts tend to plate thicker and are more repeatable than acetylacetonate (acac)-based metal salts. The one case where this was found to be not applicable was for rhenium (III) chloride, which was not successful, whereas rhenium (III) acac was successful.
Stir speeds for the solutions during the entire coating process need to be kept between 200 and 400 RPM. Faster stir rates yielded cracked spheres.
To ensure coverage of all the microspheres, an excess of metal precursor must be used. However, this causes metal particulates to crash out of the solution in addition to the metal layer that forms on the microspheres. For iridium, approximately a 6:1 ratio by weight of microspheres to iridium results in plated particles with a minimal amount of free metal. This ratio should be fine-tuned. It should also be determined for every metal of interest, as the ratios needed are likely not identical.
   It may not be possible to eliminate the excess metal, only reduce it. A method to separate coated spheres from free metal will need to be developed. Potential methods include:
      Density-based method: the microspheres should have a different density than the metal particles. Finding the correct liquid to use should cause one group to sink and the other to float. Particles can then either be drained out of the bottom of the vessel or skimmed off the top. This would require a good amount of experimentation to determine the correct liquid to use.
      Filtration: using a pair of filters of slightly different sizes, narrow the gap of acceptable particle sizes such that metal fragments that are significantly larger or smaller than the plated microspheres are rejected. Some metal particles would stay with the microspheres if they were the correct size. Some microspheres could potentially also be rejected. This is dependent upon being able to find filters that have the necessary pore sizes.
A cleaning method needs to be developed, particularly before the consolidation (vacuum furnace) step. If the microspheres are consolidated when the plating solution has been decanted off, but not washed, an odd “fuzzy-looking” layer appears that we hypothesize is metal that has crashed out as the plating solution evaporated. Odd metal fragments also form that are visually distinct from the metal fragments that form during the electroless plating step. This possibly dendritic formation is likely to cause poor adhesion in double coatings and could interfere with several of the possible separation methods listed above.

### CONCLUSIONS

The deposition of thin, continuous layers of high-temperature, corrosion-resistant metals onto oxide microspheres presents a new range of possibilities for micro-engineered powders for applications such as advanced nuclear fuels and catalysts. The metallic layer presents the possibility to decrease the temperature drop across otherwise low conductivity fuels and also provides a barrier between radioactive materials and the environment. The coating methodology described in this study provides a way to surround fuels in thin metal layers, thus enabling increased thermal conductivity and accident tolerance. Of the coating materials considered, iridium was selected as an attractive coating material for nuclear fuel applications. Experiments were successful in applying coatings of iridium and other candidate materials on cerium oxide microspheres. Additional development is needed to refine and scale processing methods.

What is claimed is:

1. An article comprising:
a spherically shaped object comprising a metal oxide-containing material, the spherically shaped object having a diameter from about 10 microns to about 1000 microns and the metal oxide-containing material including a lanthanide or an actinide; and
a coating having a layer disposed on an outer surface of the spherically shaped object, the coating including at least 50% by weight of a metal selected from Ru, Ir, Pt, Rh, Pd, Ti, Ta, Mo, W and the coating having a thickness from about 2 micrometers to about 20 micrometers.

2. The article of claim 1, wherein the metal oxide-containing material is an alpha particle emitter or a beta particle emitter.

3. The article of claim 2, wherein the metal oxide-containing material includes Ce, Pu, U, Sr, or Am.

4. The article of claim 1, wherein the coating comprises an Ir-containing alloy that includes at least one of W, Th, Ce, or Mo.

5. The article of claim 1, wherein the coating comprises a Mo-containing alloy or a W-containing alloy that includes at least one of Re or HfC.

6. The article of claim 1, wherein the coating comprises a T-containing alloy or a Mo-containing alloy that includes at least one of Re, Hf, Zr, or C.

7. The article of claim 1, wherein the coating comprises a Pt-containing alloy that includes at least one of Rh or W.

8. The article of claim 1, comprising an additional coating comprising an additional layer disposed on the layer.

9. The article of claim 8, wherein the layer comprises Ir and the additional layer comprises Mo.

10. The article of claim 1, wherein the spherically shaped objects are infused with one or more radioactive isotopes.

11. A method comprising:
providing a number of spherically shaped objects comprising a metal oxide-containing material, the spherically shaped object having a diameter from about 10 microns to about 1000 microns and the metal oxide-containing material including a lanthanide or an actinide;
combining the number of spherically shaped objects into a container that comprises one or more first solutions to produce a number of functionalized objects, the number of functionalized objects having a plurality of instances of one or more functional groups coupled to surfaces of the number of functionalized objects; and
combining the number of functionalized objects with one or more second solutions to produce a number of metal coated objects having one or more layers of a metallic coating encasing the number of spherically shaped objects, wherein the one or more second solutions include one or more metallic materials and the one or more layers of the metallic coating are comprised of the one or more metallic materials.

12. The method of claim 11, wherein the one or more functional groups comprise amine-containing functional groups.

13. The method of claim 12, first solutions comprising a nitrogen source to add nitrogen to surfaces of the number of spherically shaped objects and produce metal oxide nitrogen objects.

14. The method of claim 13, wherein the nitrogen source comprises an aqueous solution includes from about 10% by volume to about 30% by volume of a 13 molar to 16 molar ammonium hydroxide solution.

15. The method of claim 13, wherein the one or more first solutions include one or more additional solutions to convert the nitrogen attached to the surfaces of the spherically shaped objects to the amine-containing functional groups.

16. The method of claim 15, wherein the one or more first solutions include (3-aminopropyl) trimethoxysilane (APTMS) to convert the nitrogen atoms attached to the surfaces of the spherically shaped objects to the amine-containing functional groups.

17. The method of claim 11, wherein the one or more second solutions comprise a potassium hydroxide and ethylene glycol solution and an amount of 1-butyl-3-methylimidazoliumtetrafluoroborate (BMIM-BF₄).

18. The method of claim 11, wherein the one or more second solutions are mixed with the functionalized objects at speeds from about 100 revolutions per minute (RPM) to about 500 RPM and heated at temperatures from about 100° C. to about 300° C.

19. An article comprising:
a body having a storage area comprising a plurality of compartments;
individual compartments of the plurality of compartments located adjacent to at least one additional compartment of the plurality of compartments, the individual compartments having a geometric shape; and
the individual compartments being formed from a metallic material comprising at least one of titanium, iridium, platinum, nickel, a nickel alloy, or tantalum.

20. The article of claim 19, wherein:
a protective structure is formed around the body;
at least a portion of the individual compartments are configured to store radioisotope heating and power sources; and
individual compartments of the plurality of compartments have sides with dimensions from about 1 millimeter (mm) to about 100 mm.
